(19) United States
(12) Patent Application Publication
(10) Pub. No.: US 2026/0252807 A1
(43) Pub. Date: Aug. 27, 2026

(54) SYSTEM

(71) Applicant: SoftBank Group Corp., Tokyo (JP)

(72) Inventor: Takanori ISHII, Tokyo (JP)

(73) Assignee: SoftBank Group Corp., Tokyo (JP)

(21) Appl. No.: 19/537,535

(22) Filed: Feb. 12, 2026

(30) Foreign Application Priority Data
Feb. 21, 2025 (JP) 2025-026996

(51) Int. Cl. G06F 40/30; G06F 3/01; G06F 40/284

(52) U.S. Cl. CPC G06F 40/30; G06F 3/011; G06F 40/284; G06F 2203/011

(57) ABSTRACT

The system according to the embodiment comprises a collection unit, a classification unit, an analysis unit, a generation unit, and a provision unit. The collection unit collects languages of various countries and regions. The classification unit classifies the languages collected by the collection unit. The analysis unit analyzes the languages classified by the classification unit and analyzes differences in meaning, nuance, and usage. The generation unit generates languages based on information analyzed by the analysis unit. The provision unit provides the languages generated by the generation unit.

### CROSS-REFERENCE TO RELATED APPLICATION

The present application claims priority to and incorporates by reference the entire contents of Japanese Patent Application No. 2025-026996 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to accurately understand and share differences and nuances of languages of various countries and regions.

### SUMMARY OF THE INVENTION

The system according to the embodiment comprises a collection unit, a classification unit, an analysis unit, a generation unit, and a provision unit. The collection unit collects languages of various countries and regions. The classification unit classifies the languages collected by the collection unit. The analysis unit analyzes the languages classified by the classification unit and analyzes differences in meaning, nuance, and usage. The generation unit generates languages based on information analyzed by the analysis unit. The provision unit provides the languages generated by the generation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

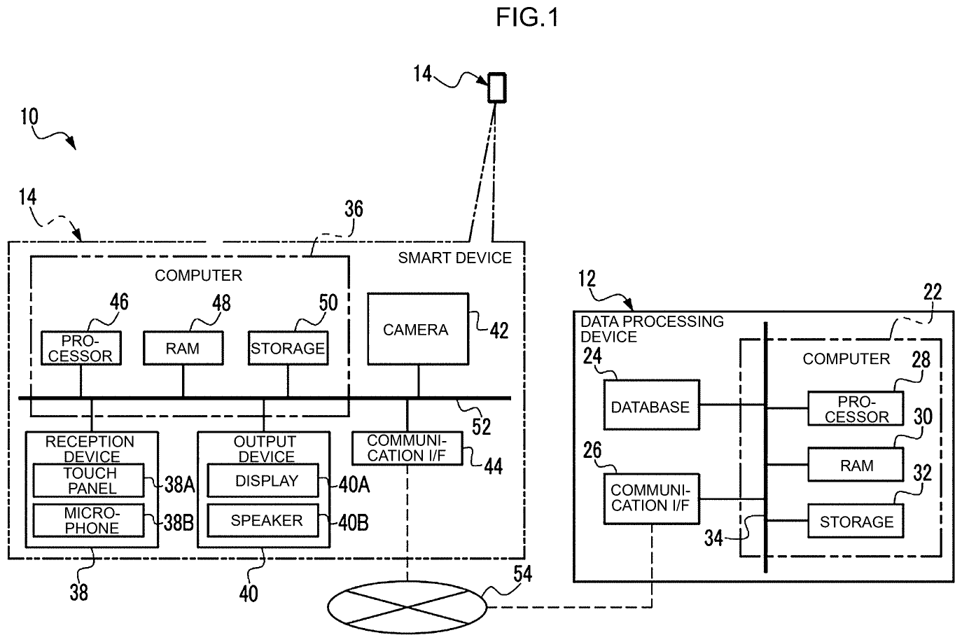

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

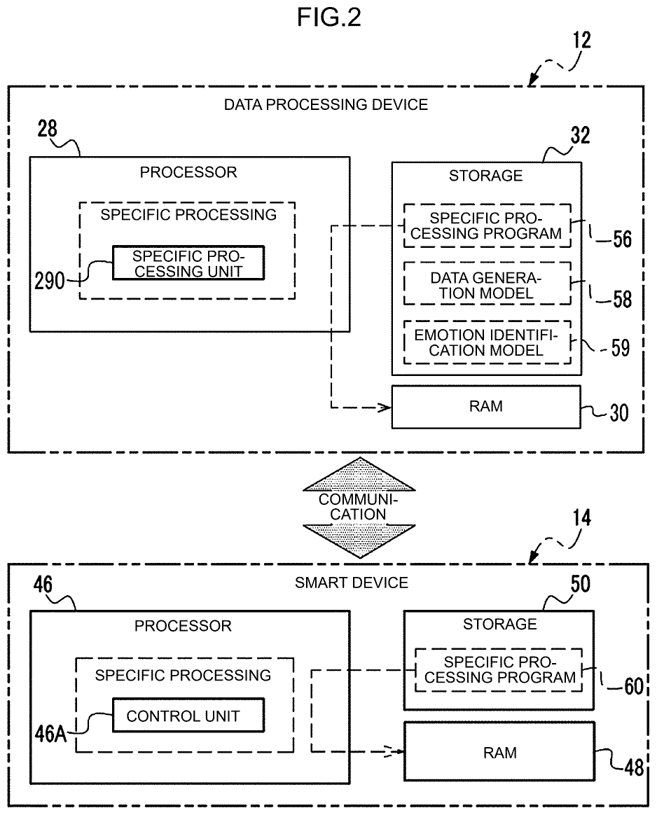

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The new language generation system according to the embodiment of the present invention is a system that utilizes the natural language understanding features of generative AI to develop a new language in which meaning and nuance can be shared and understood universally across the world. This new language generation system collects languages of various countries and regions, classifies them while considering differences in culture, historical background, and customs, understands differences in meaning, nuance, and usage, and generates a new language in which meaning and nuance can be shared and understood globally. For example, the new language generation system allows a user to input “I want to go from XX to XX.” In this case, the user only needs to input the departure point and destination. For instance, the user may input “I want to go from home to the station.” This information is input to the generative AI. Next, the generative AI analyzes the input information and creates a video showing how to get from the current location to the destination. The generative AI calculates the optimal route based on map data and generates a video along that route. For example, if the user inputs a route from home to the station, a video along that route is generated. The generated video starts navigation according to the orientation of the user's smartphone. For example, if the user points the smartphone north, the video also starts navigation facing north. This allows the user to receive navigation in the direction they are facing. Furthermore, the video moves according to the user's walking speed. For example, if the user is walking slowly, the video also progresses slowly. This enables the user to receive navigation at their own pace. With this mechanism, the structure is simple enough for children and the elderly to use easily, making it universally appreciated. The user can receive navigation intuitively without complex operations. In addition, since the viewpoint is always based on the orientation of the smartphone, the user will not get lost, and safety is ensured because the smartphone is held horizontally while walking. For example, if the user walks with the smartphone held horizontally, the video is also displayed horizontally, allowing the user to walk safely. As a result, the new language generation system can develop a new language in which meaning and nuance can be shared and understood globally. Specifically, this new language generation system is configured by combining multiple large-scale language models and multimodal neural networks. The system first imports multilingual corpora and user input data (e.g., text, audio, images, geographic information, etc.) into the collection unit in high-dimensional tensor format, and these are normalized, tokenized, and feature-extracted in the preprocessing unit. For example, when a user inputs “I want to go from home to the station,” the input text is converted into a token sequence (e.g., [‘home’, ‘from’, ‘station’, ‘to’, ‘want to go’]), and location and time information are appended. Next, the system performs semantic structure analysis of the input sentence (e.g., extraction of departure and destination, intent estimation, context interpretation) using a Transformer-based natural language understanding model. Furthermore, map data is structured as nodes (locations) and edges (routes) by a graph neural network, and the route is determined by an optimal path search algorithm (e.g., A* search, Dijkstra's algorithm). The video generation unit uses diffusion models or GANs for 3D scene generation to create virtual space navigation videos along the route. At this time, the user's smartphone IMU sensor data (acceleration, gyro, azimuth) and walking speed data are acquired in real time, and the camera viewpoint and playback speed of the generated video are dynamically adjusted. For example, if the user holds the smartphone facing north, the video generation unit renders the camera facing north, and if the walking speed is 0.8 m/s, the video playback speed is set to 0.8×. Examples of AI input include: (1) text input: [‘home’, ‘from’, ‘station’, ‘to’, ‘want to go’], (2) location information: latitude 35.6, longitude 139.7, (3) smartphone azimuth: 90 degrees (east), (4) walking speed: 0.8 m/s, etc. Examples of AI output include: (1) optimal route information: node sequence (home→intersection A→station), (2) navigation video: sequence of image frames at 30 fps, (3) control signals to the user device: playback speed 0.8×, camera viewpoint north, etc. In subsequent processing, the system streams the generated video to the user device, and the user interface unit continuously monitors changes in device orientation and speed, feeding back to the video generation unit to optimize the navigation video in real time. As a technical effect, the present invention, unlike conventional static map displays or human-guided navigation, combines AI-based high-dimensional feature extraction, semantic understanding, dynamic video generation, and real-time adaptive control to realize an intuitive and safe navigation experience that responds immediately to the user's situation and device state. This enables the generation of a new language as a universal means of communication that transcends language and cultural barriers, and can be applied to various fields such as support for visually impaired persons, tourist guidance, educational use, and evacuation guidance during disasters. Furthermore, multilingual support and multimodal expansion of AI models realize universal design that allows users worldwide to use the system regardless of their native language or individual physical characteristics, contributing to fundamental improvements in computer technology (processing efficiency, accuracy, and usability).

The new language generation system according to the embodiment comprises a collection unit, a classification unit, an analysis unit, a generation unit, and a provision unit. The collection unit collects languages of various countries and regions. The languages of various countries and regions may include, for example, English, Chinese, Spanish, etc., but are not limited to such examples. The collection unit may collect language data from public databases on the Internet, for example. The collection unit may also collect language data provided by users. For example, when a user inputs the language they speak, the collection unit collects that language data. Furthermore, the collection unit may collect language data provided by linguists or experts. For example, when a linguist provides language data collected for research purposes, the collection unit collects that data. The classification unit classifies the languages collected by the collection unit. Classification may be performed based on criteria such as language type, usage frequency, grammatical structure, etc., but is not limited to such examples. For example, the classification unit may classify the collected language data by language type. The classification unit may also classify language data based on usage frequency. Furthermore, the classification unit may classify language data based on grammatical structure. For example, the classification unit may classify language data based on the order of subject-verb-object. The analysis unit analyzes the languages classified by the classification unit and understands differences in meaning, nuance, and usage. Analysis may be performed by methods such as semantic analysis, nuance analysis, usage analysis, etc., but is not limited to such examples. For example, the analysis unit may perform semantic analysis to understand the meaning of language data. The analysis unit may also perform nuance analysis to understand the nuance of language data. Furthermore, the analysis unit may perform usage analysis to understand the usage of language data. The generation unit generates a new language based on information analyzed by the analysis unit. Generation may be performed by methods such as using language models, generation algorithms, etc., but is not limited to such examples. For example, the generation unit may generate a new language using a language model. The generation unit may also generate a new language using a generation algorithm. Furthermore, the generation unit may construct a system for generating a new language based on the analyzed information. The provision unit provides the new language generated by the generation unit. Provision may be performed based on criteria such as notification method to the user, provision timing, etc., but is not limited to such examples. For example, the provision unit may notify the user of the generated new language. The provision unit may also provide the generated new language at a specific timing. Furthermore, the provision unit may construct a system for providing the generated new language to the user. As a result, the new language generation system according to the embodiment can develop a new language in which meaning and nuance can be shared and understood globally. Specifically, this new language generation system is configured by combining multiple large-scale language models and multimodal neural networks. The system first imports multilingual corpora and user input data (e.g., text, audio, images, geographic information, etc.) into the collection unit in high-dimensional tensor format, and these are normalized, tokenized, and feature-extracted in the preprocessing unit. For example, when a user inputs “I want to go from home to the station,” the input text is converted into a token sequence (e.g., ‘home’, ‘from’, ‘station’, ‘to’, ‘want to go’), and location and time information are appended. Next, the system performs semantic structure analysis of the input sentence (e.g., extraction of departure and destination, intent estimation, context interpretation) using a Transformer-based natural language understanding model. Furthermore, map data is structured as nodes (locations) and edges (routes) by a graph neural network, and the route is determined by an optimal path search algorithm (e.g., A* search, Dijkstra's algorithm). The video generation unit uses diffusion models or GANs for 3D scene generation to create virtual space navigation videos along the route. At this time, the user's smartphone IMU sensor data (acceleration, gyro, azimuth) and walking speed data are acquired in real time, and the camera viewpoint and playback speed of the generated video are dynamically adjusted. For example, if the user holds the smartphone facing north, the video generation unit renders the camera facing north, and if the walking speed is 0.8 m/s, the video playback speed is set to 0.8×. Examples of AI input include: (1) text input: ‘home’, ‘from’, ‘station’, ‘to’, ‘want to go’, (2) location information: latitude 35.6, longitude 139.7, (3) smartphone azimuth: 90 degrees (east), (4) walking speed: 0.8 m/s, etc. Examples of AI output include: (1) optimal route information: node sequence (home→intersection A→station), (2) navigation video: sequence of image frames at 30 fps, (3) control signals to the user device: playback speed 0.8×, camera viewpoint north, etc. In subsequent processing, the system streams the generated video to the user device, and the user interface unit continuously monitors changes in device orientation and speed, feeding back to the video generation unit to optimize the navigation video in real time. As a technical effect, the present invention, unlike conventional static map displays or human-guided navigation, combines AI-based high-dimensional feature extraction, semantic understanding, dynamic video generation, and real-time adaptive control to realize an intuitive and safe navigation experience that responds immediately to the user's situation and device state. This enables the generation of a new language as a universal means of communication that transcends language and cultural barriers, and can be applied to various fields such as support for visually impaired persons, tourist guidance, educational use, and evacuation guidance during disasters. Furthermore, multilingual support and multimodal expansion of AI models realize universal design that allows users worldwide to use the system regardless of their native language or individual physical characteristics, contributing to fundamental improvements in computer technology (processing efficiency, accuracy, and usability).

The collection unit can estimate a user's emotion and adjust the timing of language collection based on the estimated emotion of the user. For example, when the user is relaxed, the generative AI frequently collects languages. The collection unit may also reduce the frequency of language collection when the user feels stressed. Furthermore, the collection unit may temporarily stop language collection when the user is focused. By adjusting the timing of language collection according to the user's emotion, languages can be collected at more appropriate times. Emotion estimation is realized by using an emotion estimation function, for example, with an emotion engine or generative AI. The generative AI may be a text generation AI (e.g., LLM) or a multimodal generative AI, but is not limited to such examples. Some or all of the above-described processing in the collection unit may be performed using AI or without using AI. For example, the collection unit may input the user's facial expression data to the generative AI and have the generative AI perform emotion estimation. Specifically, the collection unit acquires multiple multimodal inputs for user emotion estimation, such as facial image data (e.g., RGB image 128×128 pixels), audio waveform data (e.g., 1 second of audio sampled at 16 kHz), and biometric sensor data (e.g., heart rate, skin conductance response), as high-dimensional tensors. The collection unit normalizes, removes noise, and extracts features (e.g., facial expression feature vectors, audio spectral features, time-series biometric signal features) in the preprocessing unit, and inputs them to a multimodal neural network for emotion estimation (e.g., CNN+LSTM integrated model). This neural network has image feature extraction layers, audio feature extraction layers, and time-series analysis layers for biometric signals, and finally outputs emotion labels such as “relaxed,” “stressed,” “focused” (e.g., one-hot vector [1,0,0] , etc.) and emotion scores (e.g., relaxation level 0.85, stress level 0.10, focus level 0.05) in the fully connected layer. Examples of AI input include: (1) facial image: 128×128 pixel RGB image, (2) audio waveform: 16 kHz, 1 second PCM data, (3) heart rate: 72 bpm, (4) skin conductance: 0.12 μS, etc. Examples of AI output include: (1) emotion label: relaxed, (2) emotion score: relaxation 0.85, stress 0.10, focus 0.05, etc. Based on these emotion estimation results, the collection timing control module determines collection frequency parameters (e.g., every 1 minute, every 10 minutes, collection stopped) and sends control signals to the scheduler of the language data collection process. For example, if the relaxation level is 0.8 or higher, collection is performed every 1 minute; if the stress level is 0.7 or higher, collection is performed every 30 minutes; if the focus level is 0.7 or higher, collection is temporarily stopped, implementing rule-based control. In subsequent processing, the system records the history of collection timing changes as logs and utilizes them for optimizing user experience and as retraining data for AI models. As a technical effect, the present invention dynamically optimizes collection timing according to the user's psychological state, thereby reducing user burden, suppressing unnecessary data collection, improving the quality of collected data, and enhancing the efficiency of computational and communication resources for the entire system. As a result, unlike conventional uniform data collection methods, flexible data collection responsive to individual user states is possible, enabling personalized language generation and applications in medical, educational, and welfare fields, stress detection interfaces, emotion-adaptive navigation, and various other use cases. Furthermore, the combination of AI-based high-dimensional feature extraction, multimodal inference, and real-time control contributes to fundamental improvements in computer technology (processing efficiency, accuracy, and usability).

The collection unit can analyze the usage frequency of languages in various countries and regions and select a collection method. For example, the collection unit preferentially collects languages with high usage frequency. The collection unit may also collect languages with low usage frequency under specific conditions. Furthermore, the collection unit may monitor fluctuations in usage frequency in real time and appropriately adjust the collection method. By selecting the optimal collection method based on usage frequency, languages can be collected efficiently. Some or all of the above-described processing in the collection unit may be performed using AI or without using AI. For example, the collection unit may input usage frequency data of languages in various countries and regions to the generative AI and have the generative AI select the optimal collection method. Specifically, the collection unit automatically collects language usage frequency data (e.g., occurrence count per language ID, time-series usage frequency, regional distribution) from various data sources such as public corpora on the Internet, SNS posts, news articles, and government statistics, and stores them as high-dimensional tensors (e.g., 3D tensor of language×region×time). The collection unit normalizes the data (e.g., relative frequency by dividing by total number of posts), removes noise, and smooths time-series data (e.g., moving average) in the preprocessing unit, and calculates usage frequency vectors and trend features (e.g., growth rate, fluctuation range) for each language in the feature extraction unit. The collection unit inputs these features to a recurrent neural network for time-series analysis (e.g., LSTM) or a graph neural network to perform future usage frequency prediction and clustering for each language. Examples of AI input include: (1) language ID: ‘ja’ (Japanese), ‘en’ (English), ‘es’ (Spanish), (2) region: ‘JP’, ‘US’, ‘ES’, (3) time: 2024-06-01 12:00, (4) usage frequency: 0.35, 0.25, 0.10, etc. Examples of AI output include: (1) priority collection language list: [‘ja’, ‘en’], (2) collection frequency parameters: Japanese every 1 minute, English every 5 minutes, Spanish every 30 minutes, (3) collection conditions for low-frequency languages: only during specific events, etc. Based on the AI output, the collection scheduler automatically controls the collection frequency, timing, and data source selection for each language, optimizing the overall system's communication load and storage consumption. In subsequent processing, the system records the history of changes in collection frequency and collection targets, and utilizes them for future model retraining and anomaly detection (e.g., detection of sudden changes in language trends). As a technical effect, the present invention combines real-time analysis of language usage frequency and dynamic collection control by AI, achieving significant improvements in resource efficiency, responsiveness to trend changes, and appropriate coverage of rare languages compared to conventional static and uniform collection methods. As a result, the invention can be applied to global multilingual systems, emergency language support during disasters, and various use cases in tourism, education, and medical fields, embodying technological advances in high-dimensional data analysis and autonomous control by AI.

The collection unit can perform filtering based on the user's current field of interest or activity at the time of language collection. For example, the collection unit preferentially collects languages in the user's field of interest. The collection unit may also collect related languages based on the user's activity history. Furthermore, the collection unit may appropriately change the languages to be collected when the user's field of interest changes. By performing filtering based on the user's field of interest or activity, highly relevant languages can be collected. Some or all of the above-described processing in the collection unit may be performed using AI or without using AI. For example, the collection unit may input the user's field of interest data to the generative AI and have the generative AI perform filtering. Specifically, the collection unit collects various behavioral logs such as the user's web browsing history, app usage history, search queries, subscribed news categories, and SNS post content, and maps them to a high-dimensional feature space as category IDs or topic vectors (e.g., BERT embedding, 512 dimensions). The collection unit analyzes changes in the field of interest over time using LSTM or Transformer-based time-series models and estimates the current main field of interest (e.g., sports, medical, travel, education). Examples of AI input include: (1) web browsing categories: ‘sports’, ‘medical’, ‘travel’, (2) SNS post topic vector: 512-dimensional real-valued array, (3) app usage frequency: sports app 10 times/week, medical app 2 times/week, etc. Examples of AI output include: (1) priority collection field: ‘sports’, (2) related language list: English, Japanese, Spanish, (3) filtering threshold: relevance 0.7 or higher, etc. Based on the AI output, the collection unit dynamically switches the target languages and data sources, and automatically updates the collection policy when the user's field of interest changes. In subsequent processing, the system records the filtering history and transitions in the field of interest, and utilizes them as training data for personalized language generation and recommendation systems. As a technical effect, the present invention realizes highly relevant language data collection responsive to individual user's field of interest, significantly improving user satisfaction, data utilization efficiency, and overall system personalization performance compared to conventional uniform collection methods. As a result, the invention can be applied to various fields such as education, tourism, medical care, and entertainment, embodying technological advances in high-dimensional feature extraction, dynamic control, and personalized processing by AI.

The collection unit can estimate a user's emotion and determine the priority of languages to be collected based on the estimated emotion of the user. For example, when the user is relaxed, the generative AI collects diverse languages. The collection unit may also collect only specific languages when the user feels stressed. Furthermore, the collection unit may preferentially collect important languages when the user is focused. By determining the priority of languages to be collected according to the user's emotion, more appropriate languages can be collected. Emotion estimation is realized by using an emotion estimation function, for example, with an emotion engine or generative AI. The generative AI may be a text generation AI (e.g., LLM) or a multimodal generative AI, but is not limited to such examples. Some or all of the above-described processing in the collection unit may be performed using AI or without using AI. For example, the collection unit may input the user's facial expression data to the generative AI and have the generative AI perform emotion estimation. Specifically, the collection unit acquires multiple multimodal data such as the user's facial image, audio, text input, and activity logs as high-dimensional tensors, and normalizes and extracts features (e.g., facial expression feature vectors, audio spectra, text emotion scores) in the preprocessing unit. The collection unit inputs these features to a multimodal emotion estimation neural network (e.g., CNN+LSTM+BERT integrated model) and outputs emotion labels and scores such as “relaxed,” “stressed,” “focused.” Examples of AI input include: (1) facial image: 128×128 pixel RGB image, (2) audio waveform: 16 kHz, 1 second, (3) text: ‘Today is fun’, (4) activity log: app usage 10 times/day, etc. Examples of AI output include: (1) emotion label: relaxed, (2) emotion score: relaxation 0.9, stress 0.05, focus 0.05, etc. Based on the emotion estimation results, the collection priority determination module calculates priority scores for each language (e.g., diversity-focused, specific language-focused, important language-focused) and sends control signals to the collection scheduler. For example, during relaxation, diverse language collection is performed; during stress, collection is limited to the native or familiar language; during focus, important languages related to work or study are prioritized, implementing such rules. In subsequent processing, the system records the history of priority changes and utilizes them for optimizing user experience and retraining AI models. As a technical effect, the present invention realizes flexible collection priority control according to the user's psychological state, achieving reduced user burden, improved data quality, and system efficiency. As a result, the invention can be applied to various fields such as education, medical care, welfare, and personalized services, embodying technological advances in high-dimensional feature extraction, dynamic control, and personalized processing by AI.

The collection unit can preferentially collect highly relevant languages based on the user's geographic location information at the time of language collection. For example, the collection unit preferentially collects languages of the region where the user is located. The collection unit may also collect languages of the destination when the user is traveling. Furthermore, the collection unit may appropriately change the languages to be collected when the user's location information changes. By collecting highly relevant languages based on the user's geographic location information, languages can be collected efficiently. Some or all of the above-described processing in the collection unit may be performed using AI or without using AI. For example, the collection unit may input the user's geographic location information to the generative AI and have the generative AI select highly relevant languages. Specifically, the collection unit acquires geographic location information such as latitude, longitude, and altitude in real time from the user's device GPS sensor or Wi-Fi/Bluetooth location estimation, and matches it with map databases and regional language distribution data (e.g., major language list for each region ID). The collection unit inputs the location information to a geographic clustering algorithm (e.g., K-means, DBSCAN) or a graph neural network to calculate related language scores based on current location, travel route, and stay history. Examples of AI input include: (1) latitude: 35.6895, (2) longitude: 139.6917, (3) travel speed: 1.2 m/s, (4) stay history: ‘Tokyo’, ‘Osaka’, ‘Kyoto’, etc. Examples of AI output include: (1) priority collection languages: Japanese, English, (2) relevance score: Japanese 0.95, English 0.60, (3) collection switching condition: upon arrival at a new region, etc. Based on the AI output, the collection unit automatically switches the target languages and collection frequency according to the current location or destination, responding immediately to location changes such as travel or relocation. In subsequent processing, the system records the history of location and language collection, and utilizes them as training data for tourist guidance, multilingual support during disasters, and region-specific services. As a technical effect, the present invention realizes highly relevant language data collection responsive to the user's geographic situation, significantly improving local adaptability, user satisfaction, and system efficiency compared to conventional uniform collection methods. As a result, the invention can be applied to various fields such as tourism, migration, international conferences, and multilingual support during disasters, embodying technological advances in high-dimensional feature extraction, geographic information analysis, and dynamic control by AI.

The collection unit can analyze the user's social media activity and collect related languages at the time of language collection. For example, the collection unit preferentially collects languages used by the user on social media. The collection unit may also collect languages used by the user's followers or friends. Furthermore, the collection unit may analyze trends in the user's social media activity and collect related languages. By collecting related languages based on the user's social media activity, languages can be collected efficiently. Some or all of the above-described processing in the collection unit may be performed using AI or without using AI. For example, the collection unit may input the user's social media data to the generative AI and have the generative AI select related languages. Specifically, the collection unit collects social graph data such as the user's SNS post history, comments, follower/friend list, and like/share history, and tokenizes, detects language, and extracts topics from post text using natural language processing models (e.g., BERT, Transformer). The collection unit aggregates the user's post language, languages used by followers/friends, and language distribution of trending words as high-dimensional feature vectors, and calculates relevance scores using clustering or ranking algorithms. Examples of AI input include: (1) post text: ‘Hello world!’, [symbol] , (2) follower language distribution: English 80%, Japanese 15%, Spanish 5%, (3) trending words: ‘AI’, ‘travel’, ‘health’, etc. Examples of AI output include: (1) priority collection languages: English, Japanese, (2) relevance score: English 0.85, Japanese 0.65, (3) trend collection threshold: 0.7 or higher, etc. Based on the AI output, the collection unit dynamically adjusts the target languages and collection frequency according to the user's SNS activity and network structure. In subsequent processing, the system records the history of social media activity and language collection, and utilizes them as training data for personalized language generation, trend analysis, and SNS-linked services. As a technical effect, the present invention realizes highly relevant language data collection responsive to the user's social network situation, significantly improving user satisfaction, trend adaptability, and system efficiency compared to conventional uniform collection methods. As a result, the invention can be applied to various fields such as SNS-linked services, marketing, international exchange, and information transmission during disasters, embodying technological advances in high-dimensional feature extraction, network analysis, and dynamic control by AI.

The classification unit can estimate a user's emotion and adjust the language classification criteria based on the estimated emotion of the user. For example, when the user is relaxed, the generative AI uses detailed classification criteria. The classification unit may also use simplified classification criteria when the user feels stressed. Furthermore, the classification unit may use precise classification criteria when the user is focused. By adjusting the classification criteria according to the user's emotion, more appropriate classification is possible. Emotion estimation is realized by using an emotion estimation function, for example, with an emotion engine or generative AI. The generative AI may be a text generation AI (e.g., LLM) or a multimodal generative AI, but is not limited to such examples. Some or all of the above-described processing in the classification unit may be performed using AI or without using AI. For example, the classification unit may input the user's facial expression data to the generative AI and have the generative AI perform emotion estimation. Specifically, the classification unit acquires multiple multimodal data for user emotion estimation, such as facial images (e.g., 128×128 pixel RGB images), audio waveforms (e.g., 16 kHz, 1 second), and biometric sensor data (e.g., heart rate, skin conductance), as high-dimensional tensors, and normalizes, removes noise, and extracts features (e.g., facial expression feature vectors, audio spectra, time-series biometric signal features) in the preprocessing unit. The classification unit inputs these features to a multimodal emotion estimation neural network (e.g., CNN+LSTM integrated model) and outputs emotion labels and scores such as “relaxed,” “stressed,” “focused” (e.g., relaxation level 0.85, stress level 0.10, focus level 0.05). Examples of AI input include: (1) facial image: 128×128 pixel RGB image, (2) audio waveform: 16 kHz, 1 second, (3) heart rate: 72 bpm, (4) skin conductance: 0.12 μS, etc. Examples of AI output include: (1) emotion label: relaxed, (2) emotion score: relaxation 0.85, stress 0.10, focus 0.05, etc. Based on the emotion estimation results, the classification criteria control module dynamically adjusts classification parameters (e.g., classification granularity, feature selection, threshold setting). For example, during relaxation, multidimensional classification using detailed grammatical, lexical, and semantic features is performed; during stress, simplified classification using only major language attributes is performed; during focus, precise classification specialized for technical terms and work-related vocabulary is performed. In subsequent processing, the classification unit records the history of classification criteria changes and utilizes them for optimizing user experience and retraining AI models. As a technical effect, the present invention dynamically optimizes classification criteria according to the user's psychological state, achieving reduced user burden, improved classification accuracy, and system efficiency. As a result, the invention can be applied to various fields such as education, medical care, welfare, and personalized services, embodying technological advances in high-dimensional feature extraction, dynamic control, and personalized processing by AI.

The classification unit can refer to detailed data on culture and historical background during language classification to improve classification accuracy. For example, the classification unit classifies languages considering the culture and historical background of each country. The classification unit may also classify languages considering usage scenes and context. Furthermore, the classification unit may appropriately adjust the classification criteria according to changes in culture and historical background. By referring to detailed data on culture and historical background, classification accuracy is improved. Some or all of the above-described processing in the classification unit may be performed using AI or without using AI. For example, the classification unit may input data on culture and historical background to the generative AI and have the generative AI improve classification accuracy. Specifically, the classification unit acquires cultural feature data for each country/region (e.g., religion, holidays, traditional events, education system), historical event data (e.g., wars, immigration, language policy), and social structure data (e.g., urbanization rate, literacy rate) from databases as multidimensional vectors, and normalizes, categorizes, and extracts features in the preprocessing unit as high-dimensional tensors. The classification unit inputs these cultural and historical features to a graph neural network or Transformer-based multimodal classification model and outputs cultural and historical similarity scores and cluster labels for each language. Examples of AI input include: (1) cultural feature vector: religion=Buddhism, holiday=Spring Festival, education system=9 years compulsory education, (2) historical event: high immigration influx, war experience=yes, (3) language ID: ‘ja’, ‘zh’, ‘es’, etc. Examples of AI output include: (1) classification cluster: East Asian, Latin, (2) similarity score: 0.92, 0.75, (3) classification criteria weight: culture 0.6, history 0.4, etc. Based on the AI output, the classification unit dynamically adjusts the weighting of classification criteria and clustering methods, and automatically updates the classification algorithm according to changes in culture and historical background (e.g., new immigration influx, changes in social systems). In subsequent processing, the classification unit records classification history and criteria change history, and utilizes them for future model retraining and anomaly detection. As a technical effect, the present invention quantitatively handles culture and historical background in high-dimensional feature space and combines AI-based multivariate analysis and clustering, significantly improving classification accuracy, adaptability, and explainability compared to conventional simple language attribute classification. As a result, the invention can be applied to various fields such as international exchange, education, tourism, historical research, and region-specific services, embodying technological advances in high-dimensional data analysis and dynamic control by AI.

The classification unit can classify languages based on usage scenes and context during language classification. For example, the classification unit classifies languages according to usage scenes. The classification unit may also classify languages considering context. Furthermore, the classification unit may appropriately adjust the classification criteria according to changes in usage scenes and context. By considering usage scenes and context, more appropriate classification is possible. Some or all of the above-described processing in the classification unit may be performed using AI or without using AI. For example, the classification unit may input usage scene and context data to the generative AI and have the generative AI perform classification. Specifically, the classification unit acquires usage scene information associated with language data (e.g., business conversation, daily conversation, academic papers, SNS posts) and context information (e.g., speaker attributes, location, time of day, dialogue history) as high-dimensional feature vectors, and normalizes, categorizes, and extracts features (e.g., BERT embedding, time-series features) in the preprocessing unit. The classification unit inputs these features to a Transformer-based context understanding model or LSTM-based time-series analysis model and outputs cluster labels for each usage scene and context suitability scores. Examples of AI input include: (1) usage scene: ‘business conversation’, ‘academic paper’, ‘SNS post’, (2) context vector: 512-dimensional real-valued array, (3) speaker attributes: age 30s, occupation engineer, (4) time of day: 18:00, etc. Examples of AI output include: (1) classification cluster: business, casual, (2) suitability score: 0.88, 0.65, (3) classification criteria weight: scene 0.7, context 0.3, etc. Based on the AI output, the classification unit dynamically adjusts classification criteria and clustering methods, and automatically updates the classification algorithm according to changes in usage scenes and context (e.g., new dialogue situations, changes in usage purpose). In subsequent processing, the classification unit records classification history and criteria change history, and utilizes them as training data for personalized language generation and recommendation systems. As a technical effect, the present invention quantitatively handles usage scenes and context in high-dimensional feature space and combines AI-based context understanding and dynamic classification control, significantly improving classification accuracy, adaptability, and user satisfaction compared to conventional static classification methods. As a result, the invention can be applied to various fields such as education, business, SNS, medical care, and tourism, embodying technological advances in high-dimensional feature extraction and dynamic control by AI.

The classification unit can estimate a user's emotion and adjust the display order of classification results based on the estimated emotion of the user. For example, when the user is relaxed, the generative AI displays detailed classification results. The classification unit may also display simplified classification results when the user feels stressed. Furthermore, the classification unit may preferentially display important classification results when the user is focused. By adjusting the display order of classification results according to the user's emotion, more appropriate display is possible. Emotion estimation is realized by using an emotion estimation function, for example, with an emotion engine or generative AI. The generative AI may be a text generation AI (e.g., LLM) or a multimodal generative AI, but is not limited to such examples. Some or all of the above-described processing in the classification unit may be performed using AI or without using AI. For example, the classification unit may input the user's facial expression data to the generative AI and have the generative AI perform emotion estimation. Specifically, the classification unit acquires multimodal data such as the user's facial image, audio, and activity logs as high-dimensional tensors, and normalizes and extracts features (e.g., facial expression feature vectors, audio spectra, activity patterns) in the preprocessing unit. The classification unit inputs these features to a multimodal emotion estimation neural network (e.g., CNN+LSTM+BERT integrated model) and outputs emotion labels and scores such as “relaxed,” “stressed,” “focused.” Examples of AI input include: (1) facial image: 128×128 pixel RGB image, (2) audio waveform: 16 kHz, 1 second, (3) activity log: app usage 10 times/day, etc. Examples of AI output include: (1) emotion label: relaxed, (2) emotion score: relaxation 0.9, stress 0.05, focus 0.05, etc. Based on the emotion estimation results, the classification result display control module dynamically adjusts display order parameters (e.g., detail level, importance, simplicity). For example, during relaxation, detailed classification results are displayed at the top; during stress, only major classifications are displayed concisely; during focus, important classifications related to work or study are prioritized, implementing such rules. In subsequent processing, the system records the history of display order changes and utilizes them for optimizing user experience and retraining AI models. As a technical effect, the present invention realizes flexible classification result display control according to the user's psychological state, achieving reduced user burden, optimized information presentation, and system efficiency. As a result, the invention can be applied to various fields such as education, medical care, welfare, and personalized services, embodying technological advances in high-dimensional feature extraction, dynamic control, and personalized processing by AI.

The classification unit can classify languages in consideration of geographic distribution during language classification. For example, the classification unit classifies languages considering the geographic distribution of languages in each region. The classification unit may also appropriately adjust the classification criteria according to changes in geographic distribution. Furthermore, the classification unit may evaluate the relevance of languages based on geographic distribution. By considering geographic distribution, more appropriate classification is possible. Some or all of the above-described processing in the classification unit may be performed using AI or without using AI. For example, the classification unit may input geographic distribution data to the generative AI and have the generative AI perform classification. Specifically, the classification unit acquires geographic distribution data for each language (e.g., number of speakers per latitude/longitude, major language list per region ID, migration history data) as high-dimensional tensors (e.g., 3D tensor of language×region×time), and normalizes, removes noise, and extracts features (e.g., regional distribution vectors, clustering features) in the preprocessing unit. The classification unit inputs these features to a geographic clustering algorithm (e.g., K-means, DBSCAN) or a graph neural network and outputs geographic similarity scores and cluster labels. Examples of AI input include: (1) language ID: ‘ja’, ‘en’, ‘es’, (2) region: ‘JP’, ‘US’, ‘ES’, (3) number of speakers: 1000, 500, 200, (4) time: 2024-06-01 12:00, etc. Examples of AI output include: (1) classification cluster: East Asian, Western, (2) geographic relevance score: 0.95, 0.60, (3) classification criteria weight: geography 0.8, other attributes 0.2, etc. Based on the AI output, the classification unit dynamically adjusts classification criteria and clustering methods, and automatically updates the classification algorithm according to changes in geographic distribution (e.g., new migration, urbanization progress). In subsequent processing, the classification unit records classification history and criteria change history, and utilizes them as training data for region-specific services and multilingual support during disasters. As a technical effect, the present invention quantitatively handles geographic distribution in high-dimensional feature space and combines AI-based geographic information analysis and dynamic classification control, significantly improving local adaptability, classification accuracy, and system efficiency compared to conventional static classification methods. As a result, the invention can be applied to various fields such as tourism, migration, international conferences, and multilingual support during disasters, embodying technological advances in high-dimensional feature extraction, geographic information analysis, and dynamic control by AI.

The classification unit can refer to related literature and materials during language classification to improve classification accuracy. For example, the classification unit classifies languages based on related literature and materials. The classification unit may also appropriately adjust the classification criteria according to the content of literature and materials. Furthermore, the classification unit may update the classification criteria when new literature or materials are added. By referring to related literature and materials, classification accuracy is improved. Some or all of the above-described processing in the classification unit may be performed using AI or without using AI. For example, the classification unit may input related literature and material data to the generative AI and have the generative AI improve classification accuracy. Specifically, the classification unit acquires various literature and material data such as linguistic papers, dictionaries, corpora, historical materials, and educational curricula from text databases, and tokenizes, summarizes, and extracts features (e.g., vocabulary lists, grammar rules, usage patterns) using natural language processing models (e.g., BERT, Transformer). The classification unit inputs these literature features to calculate similarity scores between literature content and target language data and classification criteria weights, and reflects them in the classification algorithm (e.g., supervised learning models, rule-based classifiers). Examples of AI input include: (1) literature text: ‘Japanese honorific system’, ‘Spanish verb conjugation’, (2) vocabulary list: 1000 words, (3) number of grammar rules: 50, etc. Examples of AI output include: (1) classification cluster: honorific, verb conjugation, (2) similarity score: 0.93, 0.81, (3) classification criteria weight: literature 0.7, other attributes 0.3, etc. Based on the AI output, the classification unit dynamically adjusts classification criteria and clustering methods, and automatically updates the classification algorithm when new literature or materials are added. In subsequent processing, the classification unit records classification history and criteria change history, and utilizes them for future model retraining and anomaly detection. As a technical effect, the present invention quantitatively handles related literature and materials in high-dimensional feature space and combines AI-based literature content analysis and dynamic classification control, significantly improving classification accuracy, adaptability, and explainability compared to conventional experience-based or manual classification methods. As a result, the invention can be applied to various fields such as education, research, translation, dictionary compilation, and language preservation, embodying technological advances in high-dimensional data analysis and dynamic control by AI.

The analysis unit can estimate a user's emotion and adjust the analysis method based on the estimated emotion of the user. For example, when the user is relaxed, the generative AI performs detailed analysis. The analysis unit may also perform simplified analysis when the user feels stressed. Furthermore, the analysis unit may perform precise analysis when the user is focused. By adjusting the analysis method according to the user's emotion, more appropriate analysis is possible. Emotion estimation is realized by using an emotion estimation function, for example, with an emotion engine or generative AI. The generative AI may be a text generation AI (e.g., LLM) or a multimodal generative AI, but is not limited to such examples. Some or all of the above-described processing in the analysis unit may be performed using AI or without using AI. For example, the analysis unit may input the user's facial expression data to the generative AI and have the generative AI perform emotion estimation. Specifically, the analysis unit acquires multiple multimodal data for user emotion estimation, such as facial images (e.g., 128×128 pixel RGB images), audio waveforms (e.g., 16 kHz, 1 second), and biometric sensor data (e.g., heart rate, skin conductance), as high-dimensional tensors, and normalizes, removes noise, and extracts features (e.g., facial expression feature vectors, audio spectra, time-series biometric signal features) in the preprocessing unit. The analysis unit inputs these features to a multimodal emotion estimation neural network (e.g., CNN+LSTM integrated model) and outputs emotion labels and scores such as “relaxed,” “stressed,” “focused” (e.g., relaxation level 0.85, stress level 0.10, focus level 0.05). Examples of AI input include: (1) facial image: 128×128 pixel RGB image, (2) audio waveform: 16 kHz, 1 second, (3) heart rate: 72 bpm, (4) skin conductance: 0.12 μS, etc. Examples of AI output include: (1) emotion label: relaxed, (2) emotion score: relaxation 0.85, stress 0.10, focus 0.05, etc. Based on the emotion estimation results, the analysis method control module dynamically adjusts analysis parameters (e.g., analysis granularity, feature selection, threshold setting). For example, during relaxation, detailed semantic analysis, nuance analysis, and usage analysis are performed in multidimensional feature space; during stress, simplified analysis using only major semantic attributes is performed; during focus, precise analysis specialized for technical terms and work-related vocabulary is performed. In subsequent processing, the analysis unit records the history of analysis method changes and utilizes them for optimizing user experience and retraining AI models. As a technical effect, the present invention dynamically optimizes analysis methods according to the user's psychological state, achieving reduced user burden, improved analysis accuracy, and system efficiency. As a result, the invention can be applied to various fields such as education, medical care, welfare, and personalized services, embodying technological advances in high-dimensional feature extraction, dynamic control, and personalized processing by AI.

The analysis unit can refer to past analysis data during language analysis to optimize the analysis algorithm. For example, the analysis unit adjusts the analysis algorithm based on past analysis data. The analysis unit may also monitor fluctuations in analysis data in real time and appropriately adjust the algorithm. Furthermore, the analysis unit may update the algorithm when new analysis data is added. By referring to past analysis data, the accuracy of the analysis algorithm is improved. Some or all of the above-described processing in the analysis unit may be performed using AI or without using AI. For example, the analysis unit may input past analysis data to the generative AI and have the generative AI optimize the analysis algorithm. Specifically, the analysis unit accumulates past analysis result data (e.g., semantic analysis results, nuance judgment scores, usage classification labels, feature vectors at the time of analysis) in a time-series database and manages them as high-dimensional tensors (e.g., analysis item×time×feature dimension). The analysis unit normalizes, removes noise, and smooths time-series data (e.g., moving average) in the preprocessing unit, and calculates analysis accuracy, error trends, and trend features (e.g., accuracy improvement rate, error frequency) in the feature extraction unit. The analysis unit inputs these features to a recurrent neural network for time-series analysis (e.g., LSTM) or a meta-learning algorithm to perform parameter optimization and automatic hyperparameter adjustment of the analysis algorithm. Examples of AI input include: (1) past analysis result: semantic label ‘request’, nuance score 0.75, (2) time: 2024-06-01 12:00, (3) error flag: 0, (4) feature vector: 512-dimensional real-valued array, etc. Examples of AI output include: (1) optimized parameter set: learning rate 0.001, feature weight 0.7, (2) algorithm selection: Transformer-based, (3) retraining timing: when new data is added, etc. Based on the AI output, the analysis unit automatically updates the parameters and model configuration of the analysis algorithm, continuously improving analysis accuracy and adaptability. In subsequent processing, the analysis unit records the history of algorithm changes and accuracy trends, and utilizes them for future model retraining and anomaly detection. As a technical effect, the present invention quantitatively handles past analysis data in high-dimensional feature space and combines AI-based time-series analysis and autonomous optimization, significantly improving analysis accuracy, adaptability, and system efficiency compared to conventional static analysis methods. As a result, the invention can be applied to various fields such as education, research, translation, medical care, and dictionary compilation, embodying technological advances in high-dimensional data analysis and dynamic control by AI.

The analysis unit can analyze languages based on the purpose and usage of the language during language analysis. For example, the analysis unit analyzes languages according to the purpose of use. The analysis unit may also analyze languages considering usage. Furthermore, the analysis unit may appropriately adjust the analysis method according to changes in purpose and usage. By considering the purpose and usage of the language, more appropriate analysis is possible. Some or all of the above-described processing in the analysis unit may be performed using AI or without using AI. For example, the analysis unit may input data on the purpose and usage of the language to the generative AI and have the generative AI perform analysis. Specifically, the analysis unit acquires usage purpose information associated with language data (e.g., business negotiation, daily conversation, academic paper, SNS post) and usage information (e.g., request, report, gratitude, question) as high-dimensional feature vectors, and normalizes, categorizes, and extracts features (e.g., BERT embedding, one-hot encoding of usage labels) in the preprocessing unit. The analysis unit inputs these features to a Transformer-based context understanding model or LSTM-based time-series analysis model and outputs semantic analysis results, nuance scores, and usage suitability scores for each purpose and usage. Examples of AI input include: (1) purpose of use: ‘business negotiation’, (2) usage: ‘request’, (3) text: ‘Please respond’, (4) feature vector: 512-dimensional real-valued array, etc. Examples of AI output include: (1) semantic analysis result: request, (2) nuance score: 0.92, (3) usage suitability: 0.88, etc. Based on the AI output, the analysis unit dynamically switches analysis methods and feature selection, and automatically updates the analysis algorithm according to changes in purpose and usage (e.g., new usage scenes, added usages). In subsequent processing, the analysis unit records analysis history and usage transitions, and utilizes them as training data for personalized language generation and recommendation systems. As a technical effect, the present invention quantitatively handles purpose and usage in high-dimensional feature space and combines AI-based context understanding and dynamic analysis control, significantly improving analysis accuracy, adaptability, and user satisfaction compared to conventional static analysis methods. As a result, the invention can be applied to various fields such as education, business, SNS, medical care, and tourism, embodying technological advances in high-dimensional feature extraction and dynamic control by AI.

The analysis unit can estimate a user's emotion and adjust the display method of analysis results based on the estimated emotion of the user. For example, when the user is relaxed, the generative AI displays detailed analysis results. The analysis unit may also display simplified analysis results when the user feels stressed. Furthermore, the analysis unit may preferentially display important analysis results when the user is focused. By adjusting the display method of analysis results according to the user's emotion, more appropriate display is possible. Emotion estimation is realized by using an emotion estimation function, for example, with an emotion engine or generative AI. The generative AI may be a text generation AI (e.g., LLM) or a multimodal generative AI, but is not limited to such examples. Some or all of the above-described processing in the analysis unit may be performed using AI or without using AI. For example, the analysis unit may input the user's facial expression data to the generative AI and have the generative AI perform emotion estimation. Specifically, the analysis unit acquires multimodal data such as the user's facial image, audio, and activity logs as high-dimensional tensors, and normalizes and extracts features (e.g., facial expression feature vectors, audio spectra, activity patterns) in the preprocessing unit. The analysis unit inputs these features to a multimodal emotion estimation neural network (e.g., CNN+LSTM+BERT integrated model) and outputs emotion labels and scores such as “relaxed,” “stressed,” “focused.” Examples of AI input include: (1) facial image: 128×128 pixel RGB image, (2) audio waveform: 16 kHz, 1 second, (3) activity log: app usage 10 times/day, etc. Examples of AI output include: (1) emotion label: relaxed, (2) emotion score: relaxation 0.9, stress 0.05, focus 0.05, etc. Based on the emotion estimation results, the analysis result display control module dynamically adjusts display parameters (e.g., detail level, importance, simplicity). For example, during relaxation, detailed analysis results are displayed at the top; during stress, only major analysis results are displayed concisely; during focus, important analysis results related to work or study are prioritized, implementing such rules. In subsequent processing, the system records the history of display method changes and utilizes them for optimizing user experience and retraining AI models. As a technical effect, the present invention realizes flexible analysis result display control according to the user's psychological state, achieving reduced user burden, optimized information presentation, and system efficiency. As a result, the invention can be applied to various fields such as education, medical care, welfare, and personalized services, embodying technological advances in high-dimensional feature extraction, dynamic control, and personalized processing by AI.

The analysis unit can determine the priority of analysis based on the usage frequency and importance of the language during language analysis. For example, the analysis unit preferentially analyzes languages with high usage frequency. The analysis unit may also preferentially analyze languages with high importance. Furthermore, the analysis unit may monitor fluctuations in usage frequency and importance in real time and appropriately adjust the priority of analysis. By determining the priority of analysis based on usage frequency and importance, analysis can be performed efficiently. Some or all of the above-described processing in the analysis unit may be performed using AI or without using AI. For example, the analysis unit may input usage frequency and importance data of languages to the generative AI and have the generative AI determine the priority of analysis. Specifically, the analysis unit automatically collects language usage frequency data (e.g., occurrence count per language ID, time-series usage frequency, regional distribution) and importance indicators (e.g., business relevance, educational curriculum priority) from various data sources such as public corpora on the Internet, SNS posts, news articles, and government statistics, and stores them as high-dimensional tensors (e.g., 4D tensor of language×region×time×importance). The analysis unit normalizes the data, removes noise, and smooths time-series data (e.g., moving average) in the preprocessing unit, and calculates usage frequency vectors, importance scores, and trend features (e.g., growth rate, fluctuation range) for each language in the feature extraction unit. The analysis unit inputs these features to a recurrent neural network for time-series analysis (e.g., LSTM) or a graph neural network to perform prediction of analysis priority and clustering for each language. Examples of AI input include: (1) language ID: ‘ja’ (Japanese), ‘en’ (English), ‘es’ (Spanish), (2) region: ‘JP’, ‘US’, ‘ES’, (3) time: 2024-06-01 12:00, (4) usage frequency: 0.35, 0.25, 0.10, (5) importance: 0.9, 0.7, 0.4, etc. Examples of AI output include: (1) priority analysis language list: [‘ja’, ‘en’], (2) analysis frequency parameters: Japanese every 1 minute, English every 5 minutes, Spanish every 30 minutes, (3) analysis conditions for low-frequency languages: only during specific events, etc. Based on the AI output, the analysis scheduler automatically controls the analysis frequency, timing, and data source selection for each language, optimizing the overall system's computational load and storage consumption. In subsequent processing, the system records the history of changes in analysis frequency and analysis targets, and utilizes them for future model retraining and anomaly detection (e.g., detection of sudden changes in language trends). As a technical effect, the present invention combines real-time analysis of language usage frequency and importance and dynamic analysis control by AI, achieving significant improvements in resource efficiency, responsiveness to trend changes, and appropriate coverage of rare languages compared to conventional static and uniform analysis methods. As a result, the invention can be applied to global multilingual systems, emergency language support during disasters, and various use cases in tourism, education, and medical fields, embodying technological advances in high-dimensional data analysis and autonomous control by AI.

The analysis unit can refer to other related data sources during language analysis to improve the accuracy of analysis. For example, the analysis unit performs analysis based on relevant data sources. Additionally, the analysis unit can appropriately adjust the analysis method in consideration of the content of the data sources. Furthermore, when new data sources are added, the analysis unit can update the analysis method. By referring to other related data sources, the accuracy of analysis is improved. Some or all of the above-described processes in the analysis unit may be performed using AI, or may be performed without using AI. For example, the analysis unit can input relevant data sources into a generative AI and have the generative AI execute accuracy improvement of the analysis. Specifically, the analysis unit acquires various external data sources such as linguistic papers, dictionaries, corpora, historical materials, educational curricula, SNS trend data, and news articles via text databases or APIs, and performs tokenization, summarization, and feature extraction (e.g., vocabulary lists, grammar rules, usage patterns, trend word distributions) using natural language processing models (e.g., BERT, Transformer). The analysis unit inputs these literature and external data features, calculates similarity scores between literature content and target language data, and analysis criterion weights, and reflects them in analysis algorithms (e.g., supervised learning models, rule-based classifiers). Examples of AI input include: (1) literature text: ‘Japanese honorific system’, ‘Spanish verb conjugation’; (2) vocabulary list: 1000 words; (3) number of grammar rules: 50; (4) trend words: ‘AI’, ‘health’, etc. Examples of AI output include: (1) analysis clusters: honorific system, verb conjugation system; (2) similarity scores: 0.93, 0.81; (3) analysis criterion weights: literature 0.7, trend 0.2, other attributes 0.1, etc. The analysis unit dynamically adjusts analysis criteria and algorithms based on AI output, and automatically updates analysis algorithms when new data sources are added. As subsequent processing, analysis history and criterion change history are recorded and utilized for future model retraining and anomaly detection. As a technical effect, the present invention quantitatively handles related literature and external data in a high-dimensional feature space, and by combining AI-based content analysis and dynamic analysis control, greatly improves analysis accuracy, adaptability, and explainability compared to conventional analysis methods dependent on empirical rules and manual work. As a result, the invention can be applied to various fields such as education, research, translation, dictionary compilation, and language preservation, and embodies technical advances in high-dimensional data analysis and dynamic control by AI.

The generation unit can estimate a user's emotion and adjust the method of generating new languages based on the estimated emotion of the user. For example, when the user is relaxed, the generative AI generates detailed language. Additionally, when the user feels stress, the generative AI can generate simplified language. Furthermore, when the user is focused, the generative AI can generate precise language. By adjusting the generation method according to the user's emotion, more appropriate language can be generated. Emotion estimation is realized, for example, by using an emotion engine or a generative AI with emotion estimation functions. The generative AI may be a text generation AI (e.g., LLM) or a multimodal generative AI, but is not limited to such examples. Some or all of the above-described processes in the generation unit may be performed using AI, or may be performed without using AI. For example, the generation unit can input user facial expression data into a generative AI and have the generative AI estimate the user's emotion. Specifically, the generation unit acquires multiple types of multimodal data for user emotion estimation, such as facial images (e.g., 128×128 pixel RGB images), audio waveforms (e.g., 16 kHz, 1 second), biometric sensor data (e.g., heart rate, skin conductance), and text input (e.g., ‘Today is fun’), as high-dimensional tensors, and performs normalization, noise removal, and feature extraction (e.g., facial expression feature vectors, audio spectra, time-series biometric signal features, text emotion scores) in a preprocessing unit. The generation unit inputs these features into a multimodal emotion estimation neural network (e.g., CNN+LSTM+BERT integrated model), which outputs emotion labels such as ‘relaxed’, ‘stressed’, ‘focused’, and scores (e.g., relaxation level 0.85, stress level 0.10, focus level 0.05). Examples of AI input include: (1) facial image: 128×128 pixel RGB image; (2) audio waveform: 16 kHz, 1 second; (3) heart rate: 72 bpm; (4) skin conductance: 0.12 μS; (5) text: ‘Today is fun’, etc. Examples of AI output include: (1) emotion label: relaxed; (2) emotion score: relaxed 0.9, stress 0.05, focus 0.05, etc. Based on the emotion estimation results, the generation method control module dynamically adjusts generation parameters (e.g., grammatical complexity, vocabulary diversity, expression granularity, generation temperature). For example, when relaxed, language with detailed grammar, diverse vocabulary, and rich expressions is generated; when stressed, language with core vocabulary, simple grammar, and short sentences is generated; when focused, language specialized in technical terms and business-related vocabulary is generated. Examples of AI input include: (1) emotion score: relaxed 0.9; (2) generation target: request text; (3) generation temperature: 0.7, etc. Examples of AI output include: (1) generated language text: ‘We kindly request your cooperation’; (2) generation detail level: high; (3) vocabulary diversity score: 0.85, etc. The generation unit records generation results in a generation history database and utilizes them for user experience optimization and AI model retraining. As a technical effect, the present invention dynamically optimizes the generation method according to the user's psychological state, thereby reducing user burden, improving generation accuracy, and enhancing system efficiency. As a result, the invention can be applied to various fields such as education, healthcare, welfare, and personalized services, and embodies technical advances in high-dimensional feature extraction, dynamic control, and personalized generation processing by AI.

The generation unit can refer to past generation data during the generation of new languages to optimize the generation algorithm. For example, the generation unit adjusts the generation algorithm based on past generation data. Additionally, the generation unit can monitor fluctuations in generation data in real time and appropriately adjust the algorithm. Furthermore, when new generation data is added, the generation unit can update the algorithm. By referring to past generation data, the accuracy of the generation algorithm is improved. Some or all of the above-described processes in the generation unit may be performed using AI, or may be performed without using AI. For example, the generation unit can input past generation data into a generative AI and have the generative AI optimize the generation algorithm. Specifically, the generation unit accumulates past generation result data (e.g., generated language text, parameter sets at the time of generation, user evaluation scores, generation history timestamps) in a time-series database and manages them as high-dimensional tensors (e.g., generation item×time×feature dimension). The generation unit performs normalization, noise removal, and time-series smoothing (e.g., moving average) in a preprocessing unit, and calculates generation accuracy, error trends, and trend features (e.g., user satisfaction improvement rate, error generation frequency) in a feature extraction unit. The generation unit inputs these features into a recurrent neural network for time-series analysis (e.g., LSTM) or meta-learning algorithms to optimize generation algorithm parameters and perform automatic hyperparameter adjustment. Examples of AI input include: (1) past generated text: ‘Please respond’; (2) user evaluation: 4.5/5; (3) time: 2024-06-01 12:00; (4) generation parameters: temperature 0.7; (5) feature vector: 512-dimensional real-valued array, etc. Examples of AI output include: (1) optimized parameter set: learning rate 0.001, generation temperature 0.6; (2) algorithm selection: Transformer-based; (3) retraining timing: when new data is added, etc. The generation unit automatically updates generation algorithm parameters and model configurations based on AI output, and continuously improves generation accuracy and adaptability. As subsequent processing, algorithm change history and accuracy transitions are recorded and utilized for future model retraining and anomaly detection. As a technical effect, the present invention quantitatively handles past generation data in a high-dimensional feature space and combines AI-based time-series analysis and autonomous optimization, greatly improving generation accuracy, adaptability, and system efficiency compared to conventional static generation methods. As a result, the invention can be applied to various fields such as education, research, translation, healthcare, and dictionary compilation, and embodies technical advances in high-dimensional data analysis and dynamic control by AI.

The generation unit can generate new languages based on usage scenes and context of the language during generation. For example, the generation unit generates languages according to the usage scene. Additionally, the generation unit can generate languages in consideration of the context. Furthermore, the generation unit can appropriately adjust the generation method according to changes in usage scenes or context. By considering usage scenes and context, more appropriate languages can be generated. Some or all of the above-described processes in the generation unit may be performed using AI, or may be performed without using AI. For example, the generation unit can input usage scene and context data into a generative AI and have the generative AI execute generation. Specifically, the generation unit acquires usage scene information associated with language data (e.g., business conversation, daily conversation, academic paper, SNS post) and context information (e.g., speaker attributes, location, time of day, dialogue history) as high-dimensional feature vectors, and performs normalization, categorization, and feature extraction (e.g., BERT embedding, time-series features) in a preprocessing unit. The generation unit inputs these features into a Transformer-based context understanding model or an LSTM-based time-series analysis model, and outputs generation cluster labels for each usage scene and context suitability scores. Examples of AI input include: (1) usage scene: ‘business conversation’, ‘academic paper’, ‘SNS post’; (2) context vector: 512-dimensional real-valued array; (3) speaker attributes: age 30s, occupation engineer; (4) time of day: 18:00, etc. Examples of AI output include: (1) generation cluster: business type, casual type; (2) suitability score: 0.88, 0.65; (3) generation criterion weights: scene 0.7, context 0.3, etc. The generation unit dynamically adjusts generation criteria and algorithms based on AI output, and automatically updates generation algorithms according to changes in usage scenes or context (e.g., new dialogue situations, change in usage purpose). As subsequent processing, generation history and criterion change history are recorded and utilized as training data for personalized language generation and recommendation systems. As a technical effect, the present invention quantitatively handles usage scenes and context in a high-dimensional feature space and combines AI-based context understanding and dynamic generation control, greatly improving generation accuracy, adaptability, and user satisfaction compared to conventional static generation methods. As a result, the invention can be applied to various fields such as education, business, SNS, healthcare, and tourism, and embodies technical advances in high-dimensional feature extraction and dynamic control by AI.

The generation unit can estimate a user's emotion and adjust the display method of the generated language based on the estimated emotion of the user. For example, when the user is relaxed, the generative AI provides a detailed display method. Additionally, when the user feels stress, the generative AI can provide a simplified display method. Furthermore, when the user is focused, the generative AI can prioritize the display of important information. By adjusting the display method according to the user's emotion, more appropriate display is possible. Emotion estimation is realized, for example, by using an emotion engine or a generative AI with emotion estimation functions. The generative AI may be a text generation AI (e.g., LLM) or a multimodal generative AI, but is not limited to such examples. Some or all of the above-described processes in the generation unit may be performed using AI, or may be performed without using AI. For example, the generation unit can input user facial expression data into a generative AI and have the generative AI estimate the user's emotion. Specifically, the generation unit acquires multimodal data such as user facial images, audio, and activity logs as high-dimensional tensors, and performs normalization and feature extraction (e.g., facial expression feature vectors, audio spectra, activity patterns) in a preprocessing unit. The generation unit inputs these features into a multimodal emotion estimation neural network (e.g., CNN+LSTM+BERT integrated model), which outputs emotion labels such as ‘relaxed’, ‘stressed’, ‘focused’, and scores. Examples of AI input include: (1) facial image: 128×128 pixel RGB image; (2) audio waveform: 16 kHz, 1 second; (3) activity log: 10 app uses/day, etc. Examples of AI output include: (1) emotion label: relaxed; (2) emotion score: relaxed 0.9, stress 0.05, focus 0.05, etc. Based on the emotion estimation results, the display method control module dynamically adjusts display parameters (e.g., detail level, importance, simplicity, display order). For example, when relaxed, detailed generated language is displayed at the top; when stressed, only key information is displayed concisely; when focused, important business or learning-related information is prioritized. As subsequent processing, display method change history is recorded and utilized for user experience optimization and AI model retraining. As a technical effect, the present invention realizes flexible control of generated language display according to the user's psychological state, achieving reduced user burden, optimized information presentation, and improved system efficiency. As a result, the invention can be applied to various fields such as education, healthcare, welfare, and personalized services, and embodies technical advances in high-dimensional feature extraction, dynamic control, and personalized processing by AI.

The generation unit can determine the priority of generation based on the usage frequency and importance of languages during the generation of new languages. For example, the generation unit preferentially generates languages with high usage frequency. Additionally, the generation unit can preferentially generate languages with high importance. Furthermore, the generation unit can monitor fluctuations in usage frequency and importance in real time and appropriately adjust the priority of generation. By determining the priority of generation based on usage frequency and importance, languages can be generated efficiently. Some or all of the above-described processes in the generation unit may be performed using AI, or may be performed without using AI. For example, the generation unit can input usage frequency and importance data of languages into a generative AI and have the generative AI determine the priority of generation. Specifically, the generation unit automatically collects language usage frequency data (e.g., occurrence count per language ID, time-series usage frequency, regional distribution) and importance indicators (e.g., business relevance, educational curriculum priority) from various data sources such as public corpora on the Internet, SNS posts, news articles, and government statistics, and stores them as high-dimensional tensors (e.g., language×region×time×importance, 4-dimensional tensor). The generation unit performs normalization, noise removal, and time-series smoothing (e.g., moving average) in a preprocessing unit, and calculates usage frequency vectors, importance scores, and trend features (e.g., growth rate, fluctuation range) for each language in a feature extraction unit. The generation unit inputs these features into a recurrent neural network for time-series analysis (e.g., LSTM) or a graph neural network to predict and cluster generation priorities for each language. Examples of AI input include: (1) language ID: ‘ja’ (Japanese), ‘en’ (English), ‘es’ (Spanish); (2) region: ‘JP’, ‘US’, ‘ES’; (3) time: 2024-06-01 12:00; (4) usage frequency: 0.35, 0.25, 0.10; (5) importance: 0.9, 0.7, 0.4, etc. Examples of AI output include: (1) priority generation language list: [‘ja’, ‘en’]; (2) generation frequency parameters: Japanese every 1 minute, English every 5 minutes, Spanish every 30 minutes; (3) generation conditions for low-frequency languages: only during specific events, etc. The generation unit automatically controls generation frequency, timing, and data source selection for each language based on AI output, optimizing overall system computational load and storage consumption. As subsequent processing, changes in generation frequency and target are recorded and utilized for future model retraining and anomaly detection (e.g., detection of sudden language trend changes). As a technical effect, the present invention combines real-time analysis of language usage frequency and importance with dynamic generation control by AI, greatly improving resource efficiency, responsiveness to trend changes, and appropriate coverage of rare languages compared to conventional static and uniform generation methods. As a result, the invention can be applied to global multilingual systems, emergency language support during disasters, and diverse use cases in tourism, education, and healthcare, and embodies technical advances in high-dimensional data analysis and autonomous control by AI.

The generation unit can refer to other related data sources during the generation of new languages to improve the accuracy of generation. For example, the generation unit performs generation based on relevant data sources. Additionally, the generation unit can appropriately adjust the generation method in consideration of the content of the data sources. Furthermore, when new data sources are added, the generation unit can update the generation method. By referring to other related data sources, the accuracy of generation is improved. Some or all of the above-described processes in the generation unit may be performed using AI, or may be performed without using AI. For example, the generation unit can input relevant data sources into a generative AI and have the generative AI execute accuracy improvement of generation. Specifically, the generation unit acquires various external data sources such as linguistic papers, dictionaries, corpora, historical materials, educational curricula, SNS trend data, and news articles via text databases or APIs, and performs tokenization, summarization, and feature extraction (e.g., vocabulary lists, grammar rules, usage patterns, trend word distributions) using natural language processing models (e.g., BERT, Transformer). The generation unit inputs these literature and external data features, calculates similarity scores between literature content and target language data, and generation criterion weights, and reflects them in generation algorithms (e.g., supervised learning models, rule-based generators). Examples of AI input include: (1) literature text: ‘Japanese honorific system’, ‘Spanish verb conjugation’; (2) vocabulary list: 1000 words; (3) number of grammar rules: 50; (4) trend words: ‘AI’, ‘health’, etc. Examples of AI output include: (1) generation clusters: honorific system, verb conjugation system; (2) similarity scores: 0.93, 0.81; (3) generation criterion weights: literature 0.7, trend 0.2, other attributes 0.1, etc. The generation unit dynamically adjusts generation criteria and algorithms based on AI output, and automatically updates generation algorithms when new data sources are added. As subsequent processing, generation history and criterion change history are recorded and utilized for future model retraining and anomaly detection. As a technical effect, the present invention quantitatively handles related literature and external data in a high-dimensional feature space, and by combining AI-based content analysis and dynamic generation control, greatly improves generation accuracy, adaptability, and explainability compared to conventional generation methods dependent on empirical rules and manual work. As a result, the invention can be applied to various fields such as education, research, translation, dictionary compilation, and language preservation, and embodies technical advances in high-dimensional data analysis and dynamic control by AI.

The provision unit can estimate a user's emotion and adjust the method of providing new languages based on the estimated emotion of the user. For example, when the user is relaxed, the generative AI provides a detailed provision method. Additionally, when the user feels stress, the generative AI can provide a simplified provision method. Furthermore, when the user is focused, the generative AI can prioritize the provision of important information. By adjusting the provision method according to the user's emotion, more appropriate provision is possible. Emotion estimation is realized, for example, by using an emotion engine or a generative AI with emotion estimation functions. The generative AI may be a text generation AI (e.g., LLM) or a multimodal generative AI, but is not limited to such examples. Some or all of the above-described processes in the provision unit may be performed using AI, or may be performed without using AI. For example, the provision unit can input user facial expression data into a generative AI and have the generative AI estimate the user's emotion. Specifically, the provision unit acquires multiple types of multimodal data for user emotion estimation, such as facial images (e.g., 128×128 pixel RGB images), audio waveforms (e.g., 16 kHz, 1 second), biometric sensor data (e.g., heart rate, skin conductance), and activity logs (e.g., 10 app uses/day), as high-dimensional tensors. The provision unit normalizes, removes noise, and extracts features (e.g., facial expression feature vectors, audio spectra, time-series biometric signal features, activity patterns) in a preprocessing unit, and inputs the data into a multimodal neural network for emotion estimation (e.g., CNN+LSTM+BERT integrated model). This neural network has image feature extraction layers, audio feature extraction layers, time-series analysis layers for biometric signals, and text feature extraction layers, and finally outputs emotion labels such as ‘relaxed’, ‘stressed’, ‘focused’ (e.g., one-hot vector [1,0,0] etc.) and emotion scores (e.g., relaxation level 0.85, stress level 0.10, focus level 0.05) in a fully connected layer. Examples of AI input include: (1) facial image: 128×128 pixel RGB image; (2) audio waveform: 16 kHz, 1 second PCM data; (3) heart rate: 72 bpm; (4) skin conductance: 0.12 μS; (5) activity log: 10 app uses/day, etc. Examples of AI output include: (1) emotion label: relaxed; (2) emotion score: relaxed 0.9, stress 0.05, focus 0.05, etc. Based on these emotion estimation results, the provision method control module dynamically adjusts provision parameters (e.g., detail level, simplicity, importance, display order, notification timing). For example, when relaxed, a provision method with detailed explanations and diverse expressions is selected; when stressed, a provision method that concisely notifies only key information is selected; when focused, a provision method that emphasizes important business or learning-related information is selected. Examples of AI input include: (1) emotion score: relaxed 0.9; (2) provision target: new language text; (3) display mode: detailed, etc. Examples of AI output include: (1) provision content: detailed language explanation; (2) display order: detailed information at the top; (3) notification timing: immediate, etc. The provision unit records provision results in a provision history database and utilizes them for user experience optimization and AI model retraining. As subsequent processing, provision method change history and user reaction logs are recorded and utilized for future model retraining and personalized optimization. As a technical effect, the present invention dynamically optimizes the provision method according to the user's psychological state, thereby reducing user burden, optimizing information presentation, improving system efficiency, and enhancing usability. As a result, the invention can be applied to various fields such as education, healthcare, welfare, personalized services, customer support, and learning support, and embodies technical advances in high-dimensional feature extraction, dynamic control, and personalized provision processing by AI.

The provision unit can refer to the user's past usage history during the provision of new languages to select an optimal provision method. For example, the provision unit adjusts the provision method based on the user's past usage history. Additionally, the provision unit can monitor fluctuations in usage history in real time and appropriately adjust the provision method. Furthermore, when new usage history is added, the provision unit can update the provision method. By referring to the user's past usage history, an optimal provision method can be selected. Some or all of the above-described processes in the provision unit may be performed using AI, or may be performed without using AI. For example, the provision unit can input the user's past usage history data into a generative AI and have the generative AI select the optimal provision method. Specifically, the provision unit accumulates the user's past language usage history (e.g., usage date and time, usage frequency, usage scene, selected display mode, user feedback, operation logs) in a time-series database and manages them as high-dimensional tensors (e.g., user×time×usage scene×display mode). The provision unit performs normalization, noise removal, and time-series smoothing (e.g., moving average) in a preprocessing unit, and calculates usage trends, preference patterns, and history fluctuation features (e.g., display mode selection rate, change rate of usage frequency) in a feature extraction unit. The provision unit inputs these features into a recurrent neural network for time-series analysis (e.g., LSTM) or a clustering algorithm to predict and select the optimal provision method for each user (e.g., detailed display, simple display, notification timing, priority information type). Examples of AI input include: (1) past usage date and time: 2024-06-01 12:00; (2) usage scene: learning, business, daily conversation; (3) display mode: detailed, simple; (4) user feedback: satisfaction 4.5/5; (5) operation log: 20 clicks/day, etc. Examples of AI output include: (1) recommended provision method: detailed display; (2) notification timing: nighttime; (3) priority information type: learning-related, etc. The provision unit automatically adjusts provision parameters (e.g., display mode, notification timing, information priority) based on AI output, responding immediately to user usage trends and history changes. As subsequent processing, provision method change history and user reaction logs are recorded and utilized for future model retraining and personalized optimization. As a technical effect, the present invention quantitatively handles the user's past usage history in a high-dimensional feature space and combines AI-based time-series analysis and personalized optimization, greatly improving user satisfaction, information presentation efficiency, and system adaptability compared to conventional static and uniform provision methods. As a result, the invention can be applied to various fields such as education, learning support, business support, healthcare, welfare, and customer service, and embodies technical advances in high-dimensional data analysis and dynamic control by AI.

The provision unit can estimate a user's emotion and adjust the frequency of providing new languages based on the estimated emotion of the user. For example, when the user is relaxed, the generative AI provides frequently. Additionally, when the user feels stress, the generative AI can reduce the provision frequency. Furthermore, when the user is focused, the generative AI can prioritize the provision of important information. By adjusting the provision frequency according to the user's emotion, languages can be provided at a more appropriate frequency. Emotion estimation is realized, for example, by using an emotion engine or a generative AI with emotion estimation functions. The generative AI may be a text generation AI (e.g., LLM) or a multimodal generative AI, but is not limited to such examples. Some or all of the above-described processes in the provision unit may be performed using AI, or may be performed without using AI. For example, the provision unit can input user facial expression data into a generative AI and have the generative AI estimate the user's emotion. Specifically, the provision unit acquires multiple types of multimodal data for user emotion estimation, such as facial images (e.g., 128×128 pixel RGB images), audio waveforms (e.g., 16 kHz, 1 second), biometric sensor data (e.g., heart rate, skin conductance), and activity logs (e.g., 10 app uses/day), as high-dimensional tensors. The provision unit normalizes, removes noise, and extracts features (e.g., facial expression feature vectors, audio spectra, time-series biometric signal features, activity patterns) in a preprocessing unit, and inputs the data into a multimodal neural network for emotion estimation (e.g., CNN+LSTM+BERT integrated model). This neural network has image feature extraction layers, audio feature extraction layers, time-series analysis layers for biometric signals, and text feature extraction layers, and finally outputs emotion labels such as ‘relaxed’, ‘stressed’, ‘focused’ and emotion scores (e.g., relaxation level 0.85, stress level 0.10, focus level 0.05) in a fully connected layer. Examples of AI input include: (1) facial image: 128×128 pixel RGB image; (2) audio waveform: 16 kHz, 1 second PCM data; (3) heart rate: 72 bpm; (4) skin conductance: 0.12 μS; (5) activity log: 10 app uses/day, etc. Examples of AI output include: (1) emotion label: relaxed; (2) emotion score: relaxed 0.9, stress 0.05, focus 0.05, etc. Based on these emotion estimation results, the provision frequency control module dynamically adjusts provision frequency parameters (e.g., every 1 minute, every 10 minutes, important information only, provision stop). For example, when relaxed, new languages are provided every 1 minute; when stressed, only key information is provided every 30 minutes; when focused, only important business or learning-related information is prioritized, implementing rule-based control. Examples of AI input include: (1) emotion score: relaxed 0.9; (2) provision target: new language text; (3) provision frequency candidates: 1 minute, 10 minutes, 30 minutes, etc. Examples of AI output include: (1) determined provision frequency: every 1 minute; (2) priority information type: important information; (3) provision stop flag: 0, etc. The provision unit records changes in provision frequency and user reaction logs, and utilizes them for future model retraining and personalized optimization. As a technical effect, the present invention dynamically optimizes provision frequency according to the user's psychological state, thereby reducing user burden, optimizing information presentation, improving system efficiency, and enhancing usability. As a result, the invention can be applied to various fields such as education, healthcare, welfare, personalized services, customer support, and learning support, and embodies technical advances in high-dimensional feature extraction, dynamic control, and personalized provision processing by AI.

The provision unit can select an optimal provision method based on the user's device information during the provision of new languages. For example, when the user is using a smartphone, the provision unit provides a method adapted to the screen size. Additionally, when the user is using a tablet, the provision unit can provide a method optimized for a larger screen. Furthermore, when the user is using a smartwatch, the provision unit can provide a concise and highly visible provision method. By selecting an optimal provision method based on the user's device information, languages can be provided efficiently. Some or all of the above-described processes in the provision unit may be performed using AI, or may be performed without using AI. For example, the provision unit can input the user's device information into a generative AI and have the generative AI select the optimal provision method. Specifically, the provision unit acquires device information of the user's terminal (e.g., device type, screen resolution, OS version, input interface, used applications) in real time, and normalizes, categorizes, and extracts features (e.g., device type one-hot, screen size numerical value, OS type ID, input method category) as high-dimensional feature vectors in a preprocessing unit. The provision unit inputs these features into a device-adaptive neural network (e.g., MLP+rule-based branching) or a decision tree model to infer the optimal provision method (e.g., display layout, font size, information amount, notification method). Examples of AI input include: (1) device type: smartphone; (2) screen resolution: 1080×1920; (3) OS version: Android 13; (4) input method: touch; (5) used app: language learning app, etc. Examples of AI output include: (1) recommended provision method: simple display; (2) font size: large; (3) notification method: push notification, etc. The provision unit automatically adjusts provision parameters (e.g., layout, font, information amount, notification method) based on AI output, responding immediately to the user's device characteristics and usage situation. As subsequent processing, provision method change history and user reaction logs are recorded and utilized for future model retraining and personalized optimization. As a technical effect, the present invention quantitatively handles the user's device information in a high-dimensional feature space and combines AI-based device-adaptive optimization, greatly improving usability, information presentation efficiency, and system adaptability compared to conventional uniform provision methods. As a result, the invention can be applied to various device environments such as smartphones, tablets, smartwatches, PCs, and IoT terminals, and embodies technical advances in high-dimensional feature extraction, dynamic control, and device-adaptive provision processing by AI.

The system according to the embodiment is not limited to the above-described examples, and various modifications are possible, for example, as follows. Specifically, the system allows for diverse technical variations such as the type and configuration of AI models, data flow, input/output specifications, control algorithms, user interfaces, database structures, communication methods, sensor integration, and security functions. The system can be implemented not only as a single large-scale language model, but also as a multimodal AI architecture that links multiple AI models (e.g., natural language understanding models, speech recognition models, image analysis models, time-series analysis models, reinforcement learning models). The system can be distributed across various hardware environments such as cloud servers, edge devices, user terminals, and IoT devices, and can adopt methods such as distributed parallel processing, real-time communication, local inference, and federated learning. The system can link each processing module for data collection, classification, analysis, generation, and provision via APIs or microservices, facilitating individual function expansion and external service integration (e.g., translation API, speech synthesis API, external dictionary integration). The system can dynamically switch processing flows, model selection, data compression, and encryption methods according to user attributes, usage status, terminal state, network bandwidth, and security policies. Furthermore, the system can combine advanced AI technologies such as model training, retraining, transfer learning, self-supervised learning, anomaly detection, and autonomous optimization to continuously improve the accuracy, efficiency, adaptability, explainability, and security of the entire system. As a technical effect, the present invention realizes flexible system configuration, diverse AI model integration, distributed processing, dynamic control, and enhanced security, greatly improving scalability, adaptability, operational efficiency, safety, and usability compared to conventional single-function, static systems. As a result, the invention can be applied to various fields such as education, healthcare, welfare, tourism, translation, international exchange, disaster response, and IoT integration, and embodies technical advances in high-dimensional data analysis, multimodal integration, distributed control, and enhanced security by AI.

The collection unit can collect user voice data in real time and convert it into text data using speech recognition technology. For example, the collection unit collects the language spoken by the user and converts the voice data into text data. Additionally, the collection unit can analyze the user's voice data and extract specific keywords or phrases. Furthermore, the collection unit can grasp the characteristics of the user's pronunciation and intonation based on the user's voice data and utilize them for language data collection. By utilizing user voice data, more accurate language data can be collected. Specifically, the collection unit acquires 16 kHz sampled audio waveform data (e.g., 1 second PCM data) from the microphone input of the user terminal in real time, and performs noise removal, volume normalization, and acoustic feature extraction (e.g., MFCC, spectrogram) in a preprocessing unit. The collection unit inputs the acoustic feature tensor into a deep neural network for speech recognition (e.g., CTC-based RNN, Transformer speech recognition model) and outputs text data as a token sequence (e.g., characters, phonemes, words). Examples of AI input include: (1) audio waveform: 16 kHz, 1 second PCM data; (2) spectrum after noise removal; (3) speaker ID: user A, etc. Examples of AI output include: (1) text data: ‘Hello’, ‘What's the weather today?’; (2) keyword extraction results: ‘weather’, ‘hello’; (3) pronunciation feature vector: vowel length 0.12 seconds, pitch 120 Hz, etc. The collection unit applies keyword extraction algorithms (e.g., attention mechanism keyword spotting) and intonation analysis models (e.g., F0 time-series analysis) based on speech recognition results and pronunciation features, and records user speech tendencies and features as high-dimensional feature vectors. As subsequent processing, collected voice text and pronunciation features are stored in a language database and utilized as training data for personalized language generation, pronunciation correction, and speech dialogue systems. As a technical effect, the present invention combines real-time speech recognition, feature extraction, keyword analysis, and pronunciation analysis, greatly improving collection accuracy, processing efficiency, and user experience compared to manual input or simple voice recording. As a result, the invention can be applied to various fields such as voice assistants, language learning, medical records, minutes creation, and accessibility support, and embodies technical advances in high-dimensional voice analysis and dynamic control by AI.

The collection unit can estimate a user's emotion and select the types of languages to be collected based on the estimated emotion of the user. For example, when the user is relaxed, the generative AI collects diverse languages. Additionally, when the user feels stress, the generative AI can preferentially collect languages close to the user's native language. Furthermore, when the user is focused, the generative AI can collect specialized languages. By selecting the types of languages to be collected according to the user's emotion, more appropriate languages can be collected. Specifically, the collection unit acquires multiple types of multimodal data for user emotion estimation, such as facial images (e.g., 128×128 pixel RGB images), audio waveforms (e.g., 16 kHz, 1 second), biometric sensor data (e.g., heart rate, skin conductance), and activity logs (e.g., 10 app uses/day), as high-dimensional tensors, and performs normalization, noise removal, and feature extraction (e.g., facial expression feature vectors, audio spectra, time-series biometric signal features, activity patterns) in a preprocessing unit. The collection unit inputs these features into a multimodal emotion estimation neural network (e.g., CNN+LSTM+BERT integrated model), which outputs emotion labels such as ‘relaxed’, ‘stressed’, ‘focused’, and scores (e.g., relaxation level 0.85, stress level 0.10, focus level 0.05). Examples of AI input include: (1) facial image: 128×128 pixel RGB image; (2) audio waveform: 16 kHz, 1 second PCM data; (3) heart rate: 72 bpm; (4) skin conductance: 0.12 μS; (5) activity log: 10 app uses/day, etc. Examples of AI output include: (1) emotion label: relaxed; (2) emotion score: relaxed 0.9, stress 0.05, focus 0.05, etc. Based on the emotion estimation results, the language selection control module dynamically determines the list of languages to be collected (e.g., multiple languages, native language, technical terms) and sends control signals to the collection scheduler. For example, when relaxed, multiple languages are collected; when stressed, collection is limited to the native language or familiar languages; when focused, business or learning-related technical languages are prioritized, implementing such rules. As subsequent processing, changes in collected language types and user reaction logs are recorded and utilized for personalized language generation and AI model retraining. As a technical effect, the present invention realizes flexible control of collected language types according to the user's psychological state, achieving reduced user burden, improved data quality, and enhanced system efficiency. As a result, the invention can be applied to various fields such as education, healthcare, welfare, and personalized services, and embodies technical advances in high-dimensional feature extraction, dynamic control, and personalized processing by AI.

The collection unit can analyze a user's social media activity and collect related languages. For example, the collection unit preferentially collects languages used by the user on social media. Additionally, the collection unit can collect languages used by the user's followers or friends. Furthermore, the collection unit can analyze trends in the user's social media activity and collect related languages. By collecting related languages based on the user's social media activity, languages can be collected efficiently. Specifically, the collection unit collects social graph data such as the user's SNS post history, comments, follower/friend lists, and like/share history, and tokenizes, determines language, and extracts topics from post text using natural language processing models (e.g., BERT, Transformer). The collection unit aggregates the user's own post languages, languages used by followers/friends, and language distribution of trend words as high-dimensional feature vectors, and calculates relevance scores using clustering and ranking algorithms. Examples of AI input include: (1) post text: ‘Hello world!’, [symbol] ; (2) follower language distribution: English 80%, Japanese 15%, Spanish 5%; (3) trend words: ‘AI’, ‘travel’, ‘health’, etc. Examples of AI output include: (1) priority collection languages: English, Japanese; (2) relevance scores: English 0.85, Japanese 0.65; (3) trend collection threshold: 0.7 or higher, etc. The collection unit dynamically adjusts the languages to be collected and collection frequency according to the user's SNS activity and network structure based on AI output. As subsequent processing, social media activity and language collection history are recorded and utilized as training data for personalized language generation, trend analysis, and SNS-linked services. As a technical effect, the present invention realizes collection of highly relevant language data in response to the user's social network situation, greatly improving user satisfaction, trend adaptability, and system efficiency compared to conventional uniform collection methods. As a result, the invention can be applied to various fields such as SNS-linked services, marketing, international exchange, and disaster information transmission, and embodies technical advances in high-dimensional feature extraction, network analysis, and dynamic control by AI.

The collection unit can preferentially collect highly relevant languages based on the user's geographic location information. For example, the collection unit preferentially collects languages of the region where the user is located. Additionally, when the user is traveling, the collection unit can collect languages of the destination. Furthermore, when the user's location information changes, the collection unit can appropriately change the languages to be collected. By collecting highly relevant languages based on the user's geographic location information, languages can be collected efficiently. Specifically, the collection unit acquires geographic location information such as latitude, longitude, and altitude (e.g., latitude 35.6895, longitude 139.6917) in real time from the GPS sensor or Wi-Fi/Bluetooth location estimation of the user terminal, and matches it with map databases and regional language distribution data (e.g., major language lists for each region ID). The collection unit inputs location information into geographic clustering algorithms (e.g., K-means, DBSCAN) or graph neural networks to calculate relevant language scores based on current location, travel route, and stay history. Examples of AI input include: (1) latitude: 35.6895; (2) longitude: 139.6917; (3) travel speed: 1.2 m/s; (4) stay history: ‘Tokyo’, ‘Osaka’, ‘Kyoto’, etc. Examples of AI output include: (1) priority collection languages: Japanese, English; (2) relevance scores: Japanese 0.95, English 0.60; (3) collection switching condition: upon arrival at a new region, etc. The collection unit automatically switches the languages to be collected and collection frequency according to current location and destination based on AI output, and responds immediately to location changes such as travel or relocation. As subsequent processing, location and language collection history are recorded and utilized as training data for tourism guidance, multilingual support during disasters, and region-specific services. As a technical effect, the present invention realizes collection of highly relevant language data in response to the user's geographic situation, greatly improving local adaptability, user satisfaction, and system efficiency compared to conventional uniform collection methods. As a result, the invention can be applied to various fields such as tourism, migration, international conferences, and multilingual support during disasters, and embodies technical advances in high-dimensional feature extraction, geographic information analysis, and dynamic control by AI.

The collection unit can perform filtering based on the user's field of interest or activity. For example, the collection unit preferentially collects languages in fields of interest to the user. Additionally, the collection unit can collect related languages based on the user's activity history. Furthermore, when the user's field of interest changes, the collection unit can appropriately change the languages to be collected. By performing filtering based on the user's field of interest or activity, highly relevant languages can be collected. Specifically, the collection unit collects various activity logs such as the user's web browsing history, app usage history, search queries, subscribed news categories, and SNS post content, and maps them to a high-dimensional feature space as category IDs or topic vectors (e.g., BERT embedding, 512 dimensions). The collection unit analyzes changes in fields of interest over time using LSTM or Transformer-based time-series models and estimates the current main field of interest (e.g., sports, healthcare, travel, education). Examples of AI input include: (1) web browsing categories: ‘sports’, ‘healthcare’, ‘travel’; (2) SNS post topic vector: 512-dimensional real-valued array; (3) app usage frequency: sports app 10 times/week, healthcare app 2 times/week, etc. Examples of AI output include: (1) priority collection field: ‘sports’; (2) related language list: English, Japanese, Spanish; (3) filtering threshold: relevance 0.7 or higher, etc. The collection unit dynamically switches the languages to be collected and data sources based on AI output, and automatically updates the collection policy when the user's field of interest changes. As subsequent processing, filtering history and transitions in fields of interest are recorded and utilized as training data for personalized language generation and recommendation systems. As a technical effect, the present invention realizes collection of highly relevant language data in response to individual user fields of interest, greatly improving user satisfaction, data utilization efficiency, and overall system personalization performance compared to conventional uniform collection methods. As a result, the invention can be applied to various fields such as education, tourism, healthcare, and entertainment, and embodies technical advances in high-dimensional feature extraction, dynamic control, and personalized processing by AI.

The collection unit can estimate a user's emotion and determine the priority of languages to be collected based on the estimated emotion of the user. For example, when the user is relaxed, the generative AI collects diverse languages. Additionally, when the user feels stress, the generative AI can limit collection to specific languages. Furthermore, when the user is focused, the generative AI can preferentially collect important languages. By determining the priority of languages to be collected according to the user's emotion, more appropriate languages can be collected. Specifically, the collection unit acquires multimodal data such as user facial images, audio, text input, and activity logs as high-dimensional tensors, and performs normalization and feature extraction (e.g., facial expression feature vectors, audio spectra, text emotion scores) in a preprocessing unit. The collection unit inputs these features into a multimodal emotion estimation neural network (e.g., CNN+LSTM+BERT integrated model), which outputs emotion labels such as ‘relaxed’, ‘stressed’, ‘focused’ and scores. Examples of AI input include: (1) facial image: 128×128 pixel RGB image; (2) audio waveform: 16 kHz, 1 second; (3) text: ‘Today is fun’; (4) activity log: 10 app uses/day, etc. Examples of AI output include: (1) emotion label: relaxed; (2) emotion score: relaxed 0.9, stress 0.05, focus 0.05, etc. Based on the emotion estimation results, the collection priority determination module calculates priority scores for each language (e.g., diversity emphasis, specific language emphasis, important language emphasis) and sends control signals to the collection scheduler. For example, when relaxed, multiple languages are collected; when stressed, collection is limited to the native language or familiar languages; when focused, business or learning-related important languages are prioritized, implementing such rules. As subsequent processing, priority change history is recorded and utilized for user experience optimization and AI model retraining. As a technical effect, the present invention realizes flexible control of collection priority according to the user's psychological state, achieving reduced user burden, improved data quality, and enhanced system efficiency. As a result, the invention can be applied to various fields such as education, healthcare, welfare, and personalized services, and embodies technical advances in high-dimensional feature extraction, dynamic control, and personalized processing by AI.

The classification unit can estimate a user's emotion and adjust the language classification criteria based on the estimated emotion of the user. For example, when the user is relaxed, the generative AI uses detailed classification criteria. Additionally, when the user feels stress, the generative AI can use simplified classification criteria. Furthermore, when the user is focused, the generative AI can use precise classification criteria. By adjusting the classification criteria according to the user's emotion, more appropriate classification is possible. Specifically, the classification unit acquires multiple types of multimodal data for user emotion estimation, such as facial images (e.g., 128×128 pixel RGB images), audio waveforms (e.g., 16 kHz, 1 second), biometric sensor data (e.g., heart rate, skin conductance), and activity logs (e.g., 10 app uses/day), as high-dimensional tensors, and performs normalization, noise removal, and feature extraction (e.g., facial expression feature vectors, audio spectra, time-series biometric signal features, activity patterns) in a preprocessing unit. The classification unit inputs these features into a multimodal emotion estimation neural network (e.g., CNN+LSTM integrated model), which outputs emotion labels such as ‘relaxed’, ‘stressed’, ‘focused’ and scores (e.g., relaxation level 0.85, stress level 0.10, focus level 0.05). Examples of AI input include: (1) facial image: 128×128 pixel RGB image; (2) audio waveform: 16 kHz, 1 second; (3) heart rate: 72 bpm; (4) skin conductance: 0.12 μS; (5) activity log: 10 app uses/day, etc. Examples of AI output include: (1) emotion label: relaxed; (2) emotion score: relaxed 0.85, stress 0.10, focus 0.05, etc. Based on the emotion estimation results, the classification criteria control module dynamically adjusts classification parameters (e.g., classification granularity, feature selection, threshold setting). For example, when relaxed, multidimensional classification using detailed grammar, vocabulary, and semantic features is performed; when stressed, simple classification using only major language attributes is performed; when focused, precise classification specialized in technical terms and business-related vocabulary is performed. As subsequent processing, the classification unit records classification criteria change history and utilizes it for user experience optimization and AI model retraining. As a technical effect, the present invention dynamically optimizes classification criteria according to the user's psychological state, achieving reduced user burden, improved classification accuracy, and enhanced system efficiency. As a result, the invention can be applied to various fields such as education, healthcare, welfare, and personalized services, and embodies technical advances in high-dimensional feature extraction, dynamic control, and personalized processing by AI.

The classification unit can refer to detailed data on culture and historical background during language classification to improve classification accuracy. For example, the classification unit classifies languages in consideration of the culture and historical background of each country. Additionally, the classification unit can classify languages in consideration of usage scenes and context. Furthermore, the classification unit can appropriately adjust classification criteria according to changes in culture and historical background. By referring to detailed data on culture and historical background, classification accuracy is improved. Specifically, the classification unit acquires cultural feature data of each country/region (e.g., religion, holidays, traditional events, education system), historical event data (e.g., wars, immigration, language policies), and social structure data (e.g., urbanization rate, literacy rate) from databases as multidimensional vectors, and normalizes, categorizes, and extracts features as high-dimensional tensors in a preprocessing unit. The classification unit inputs these cultural and historical features into a graph neural network or Transformer-based multimodal classification model, and outputs cultural and historical similarity scores and cluster labels for each language. Examples of AI input include: (1) cultural feature vector: religion=Buddhism, holiday=Spring Festival, education system=9 years compulsory education; (2) historical event: high immigration influx, war experience=present; (3) language ID: ‘ja’, ‘zh’, ‘es’, etc. Examples of AI output include: (1) classification cluster: East Asian type, Latin type; (2) similarity score: 0.92, 0.75; (3) classification criterion weights: culture 0.6, history 0.4, etc. The classification unit dynamically adjusts classification criterion weighting and clustering methods based on AI output, and automatically updates classification algorithms according to changes in culture and historical background (e.g., new immigration influx, changes in social systems). As subsequent processing, classification history and criterion change history are recorded and utilized for future model retraining and anomaly detection. As a technical effect, the present invention quantitatively handles culture and historical background in a high-dimensional feature space and combines multivariate analysis and clustering by AI, greatly improving classification accuracy, adaptability, and explainability compared to conventional simple language attribute classification. As a result, the invention can be applied to various fields such as international exchange, education, tourism, historical research, and region-specific services, and embodies technical advances in high-dimensional data analysis and dynamic control by AI.

The classification unit can classify languages based on usage scenes and context during language classification. For example, classification may be performed according to the usage scene of the language. Additionally, the classification unit can classify languages by considering the context of the language. Furthermore, the classification unit can appropriately adjust the classification criteria in response to changes in usage scenes or context. By considering the usage scene and context of the language, more appropriate classification becomes possible. Specifically, the classification unit acquires usage scene information (e.g., business conversation, daily conversation, academic paper, SNS post) and context information (e.g., speaker attributes, location, time zone, dialogue history) associated with language data as high-dimensional feature vectors, and performs normalization, categorization, and feature extraction (e.g., BERT embedding, time-series features) in the preprocessing unit. The classification unit inputs these features into a Transformer-based context understanding model or an LSTM-based time-series analysis model, and outputs cluster labels for each usage scene and context suitability scores. Examples of AI input include: (1) usage scene: ‘business conversation’, ‘academic paper’, ‘SNS post’; (2) context vector: 512-dimensional real-valued array; (3) speaker attributes: age in 30s, occupation engineer; (4) time zone: 18:00, etc. Examples of AI output include: (1) classification cluster: business type, casual type; (2) suitability score: 0.88, 0.65; (3) classification criteria weights: scene 0.7, context 0.3, etc. The classification unit dynamically adjusts classification criteria and clustering methods based on AI output, and automatically updates the classification algorithm in response to changes in usage scene or context (e.g., new dialogue situations, change in usage purpose). As subsequent processing, classification history and criteria change history are recorded and utilized as training data for personalized language generation and recommendation systems. As a technical effect, the present invention quantitatively handles usage scenes and context in a high-dimensional feature space and combines AI-based context understanding and dynamic classification control, thereby greatly improving classification accuracy, adaptability, and user satisfaction compared to conventional static classification methods. As a result, the invention can be applied to various fields such as education, business, SNS, healthcare, and tourism, and embodies technological advances in high-dimensional feature extraction and dynamic control by AI.

The classification unit can estimate a user's emotion and adjust the display order of classification results based on the estimated emotion of the user. For example, when the user is relaxed, the generation AI displays detailed classification results. Additionally, when the user is feeling stressed, the generation AI can display simplified classification results. Furthermore, when the user is focused, the generation AI can preferentially display important classification results. By adjusting the display order of classification results according to the user's emotion, more appropriate display becomes possible. Specifically, the classification unit acquires multimodal data such as the user's facial images, voice, and activity logs as high-dimensional tensors, and performs normalization and feature extraction (e.g., facial expression feature vectors, voice spectrograms, behavioral patterns) in the preprocessing unit. The classification unit inputs these features into a multimodal emotion estimation neural network (e.g., CNN+LSTM+BERT integrated model) and outputs emotion labels and scores such as “relaxed”, “stressed”, and “focused”. Examples of AI input include: (1) facial image: 128×128 pixel RGB image; (2) voice waveform: 16 kHz, 1 second; (3) activity log: app usage count 10 times/day, etc. Examples of AI output include: (1) emotion label: relaxed; (2) emotion score: relaxed 0.9, stressed 0.05, focused 0.05, etc. Based on the emotion estimation results, the classification result display control module dynamically adjusts display order parameters (e.g., level of detail, importance, simplicity). For example, when relaxed, detailed classification results are displayed at the top; when stressed, only major classifications are displayed concisely; when focused, important classifications related to work or study are displayed preferentially, and so on. As subsequent processing, display order change history is recorded and utilized for user experience optimization and AI model retraining. As a technical effect, the present invention realizes flexible control of classification result display according to the user's psychological state, achieving reduced user burden, optimized information presentation, and improved system efficiency. As a result, the invention can be applied to various fields such as education, healthcare, welfare, and personalized services, and embodies technological advances in high-dimensional feature extraction, dynamic control, and personalized processing by AI.

Below, the processing flow of Example of the Embodiment is briefly described. Specifically, the present system is configured such that each module—collection unit, classification unit, analysis unit, generation unit, and provision unit—operates in cooperation, exchanging high-dimensional tensor data, feature vectors, and control signals in real time between modules. The system acquires various data (e.g., text, voice, image, location information, activity logs) from user input and external data sources in the collection unit, and performs normalization, feature extraction, and noise removal in the preprocessing unit. The collection unit uses AI models (e.g., speech recognition model, emotion estimation model, topic extraction model) to convert input data into text, assign emotion labels, and vectorize fields of interest, then transmits them to the classification unit. The classification unit uses AI models (e.g., BERT, Transformer, LSTM) to cluster and classify language data based on multidimensional features such as language type, usage frequency, grammatical structure, cultural and historical characteristics, usage scene, and context, and passes the results to the analysis unit. The analysis unit uses AI models (e.g., semantic analysis model, nuance analysis model, usage analysis model) to analyze the meaning, nuance, and usage of the classified language data in a high-dimensional feature space, and sends the analysis results (e.g., meaning labels, nuance scores, usage suitability) to the generation unit. The generation unit uses AI models (e.g., large language model, multimodal generation model, time-series generation model) to integrate analysis results, user state, usage history, and external knowledge, and generate new language text, voice, images, videos, etc. The provision unit uses AI models (e.g., emotion-adaptive display control model, device-adaptive provision model) to dynamically optimize the display method, notification timing, information amount, and priority of the generated language according to the user's emotion, device information, and usage history, and provides them to the user terminal. Each module continuously performs parameter optimization, model retraining, anomaly detection, and personalized control based on AI output results and history data. As a technical effect, the present invention combines high-dimensional feature extraction, multimodal analysis, dynamic control, personalized generation, and device-adaptive provision by AI, thereby greatly improving accuracy, efficiency, adaptability, usability, and scalability compared to conventional static and uniform language processing systems. As a result, the invention can be applied to various fields such as education, healthcare, welfare, tourism, translation, international exchange, disaster response, and accessibility support, and embodies technological advances in high-dimensional data analysis, dynamic control, and personalized processing by AI.
Step 1: The collection unit collects languages of various countries and regions. Languages of various countries and regions include, for example, English, Chinese, Spanish, and the like, but are not limited thereto. The collection unit may collect language data from public databases on the Internet, for example. The collection unit can also collect language data provided by users. For example, when a user inputs the language they speak, the collection unit collects that language data. Furthermore, the collection unit can collect language data provided by linguists or experts. For example, when a linguist provides language data collected for research purposes, the collection unit collects that data. Step 2: The classification unit classifies the languages collected by the collection unit. Classification is performed based on criteria such as language type, usage frequency, grammatical structure, and the like, but is not limited thereto. For example, the classification unit classifies the collected language data by language type. The classification unit can also classify language data based on usage frequency. Furthermore, the classification unit can classify language data based on grammatical structure. For example, the classification unit classifies language data based on the order of subject-verb-object. Step 3: The analysis unit analyzes the languages classified by the classification unit and understands differences in meaning, nuance, and usage. Analysis is performed by methods such as semantic analysis, nuance analysis, usage analysis, and the like, but is not limited thereto. For example, the analysis unit performs semantic analysis to understand the meaning of language data. The analysis unit can also perform nuance analysis to understand the nuance of language data. Furthermore, the analysis unit can perform usage analysis to understand the usage of language data. Step 4: The generation unit generates new languages based on information analyzed by the analysis unit. Generation is performed by methods such as using language models, generation algorithms, and the like, but is not limited thereto. For example, the generation unit generates new languages using a language model. The generation unit can also generate new languages using generation algorithms. Furthermore, the generation unit can construct a system for generating new languages based on analyzed information. Step 5: The provision unit provides the new languages generated by the generation unit. Provision is performed based on criteria such as notification method to the user, provision timing, and the like, but is not limited thereto. For example, the provision unit notifies the user of the newly generated language. The provision unit can also provide the newly generated language at a specific timing. Furthermore, the provision unit can construct a system for providing the newly generated language to the user. Specifically, in Step 1, the system imports language data (e.g., text, voice, image, location information) in high-dimensional tensor format from various data sources such as public corpora on the Internet, SNS posts, news articles, user input, and expert-provided data into the collection unit, and performs normalization, tokenization, and feature extraction (e.g., speech-to-text conversion, image-to-text conversion, language ID assignment) in the preprocessing unit. In Step 2, the classification unit uses AI models (e.g., BERT, Transformer, LSTM) to cluster and classify language data based on multidimensional features such as language type, usage frequency, grammatical structure, cultural and historical characteristics, usage scene, and context, and transmits classification results (e.g., cluster labels, classification scores) to the analysis unit. In Step 3, the analysis unit uses AI models (e.g., semantic analysis model, nuance analysis model, usage analysis model) to analyze the meaning, nuance, and usage of the classified language data in a high-dimensional feature space, and sends analysis results (e.g., meaning labels, nuance scores, usage suitability) to the generation unit. In Step 4, the generation unit uses AI models (e.g., large language model, multimodal generation model, time-series generation model) to integrate analysis results, user state, usage history, and external knowledge, and generate new language text, voice, images, videos, etc. In Step 5, the provision unit uses AI models (e.g., emotion-adaptive display control model, device-adaptive provision model) to dynamically optimize the display method, notification timing, information amount, and priority of the generated language according to the user's emotion, device information, and usage history, and provides them to the user terminal. In each step, parameter optimization, model retraining, anomaly detection, and personalized control are continuously performed based on AI output results and history data. As a technical effect, the present invention combines high-dimensional feature extraction, multimodal analysis, dynamic control, personalized generation, and device-adaptive provision by AI, thereby greatly improving accuracy, efficiency, adaptability, usability, and scalability compared to conventional static and uniform language processing systems. As a result, the invention can be applied to various fields such as education, healthcare, welfare, tourism, translation, international exchange, disaster response, and accessibility support, and embodies technological advances in high-dimensional data analysis, dynamic control, and personalized processing by AI.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT® (Internet search <URL:https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described collection unit, classification unit, analysis unit, generation unit, and provision unit is implemented by at least one of, for example, a smart device 14 and a data processing apparatus 12. For example, the collection unit collects language data from a public database on the Internet via a communication I/F 44 of the smart device 14. The classification unit classifies the language data collected, for example, by a specific processing unit 290 of the data processing apparatus 12. The analysis unit analyzes the language data classified, for example, by the specific processing unit 290 of the data processing apparatus 12. The generation unit generates a new language based on information analyzed, for example, by the specific processing unit 290 of the data processing apparatus 12. The provision unit provides the new language generated, for example, by a control unit 46A of the smart device 14 to the user. The correspondence between each unit and the apparatus or control unit is not limited to the above examples and various modifications are possible.

### Second Embodiment

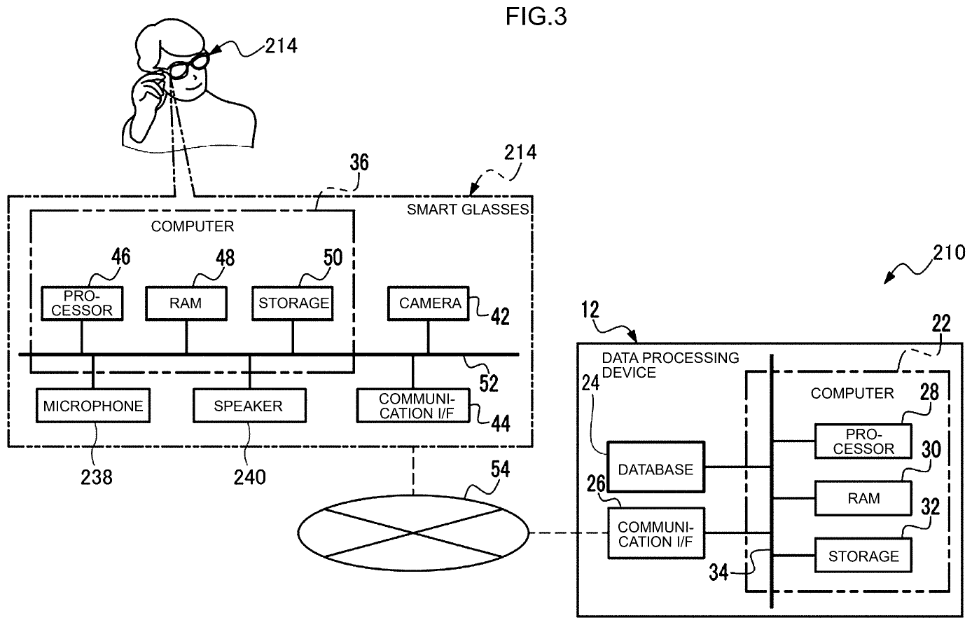

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

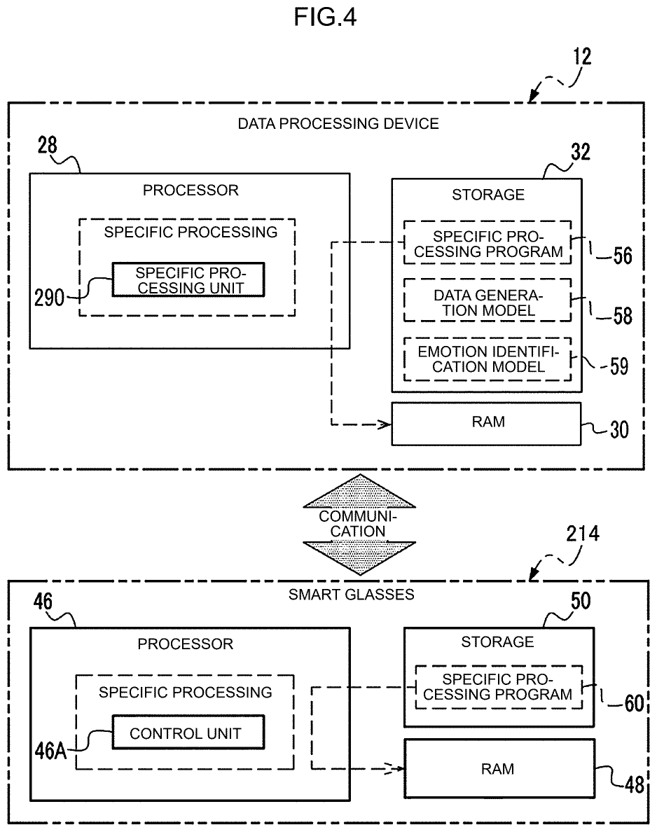

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described collection unit, classification unit, analysis unit, generation unit, and provision unit is implemented by at least one of, for example, smart glasses 214 and a data processing apparatus 12. For example, the collection unit collects language data from a public database on the Internet via a communication I/F 44 of the smart glasses 214. The classification unit classifies the language data collected, for example, by a specific processing unit 290 of the data processing apparatus 12. The analysis unit analyzes the language data classified, for example, by the specific processing unit 290 of the data processing apparatus 12. The generation unit generates a new language based on information analyzed, for example, by the specific processing unit 290 of the data processing apparatus 12. The provision unit provides the new language generated, for example, by a control unit 46A of the smart glasses 214 to the user. The correspondence between each unit and the apparatus or control unit is not limited to the above examples and various modifications are possible.

### Third Embodiment

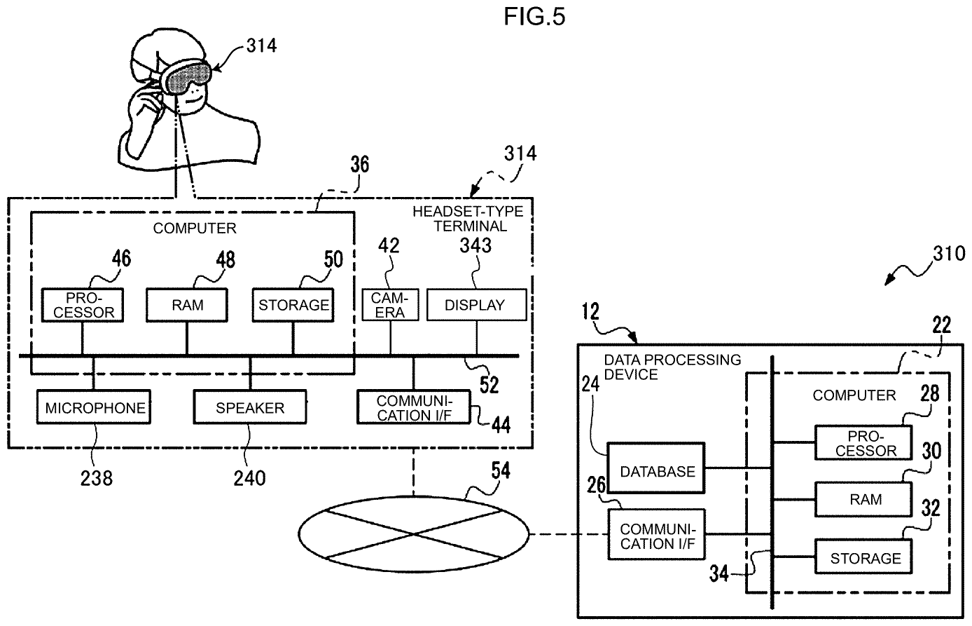

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

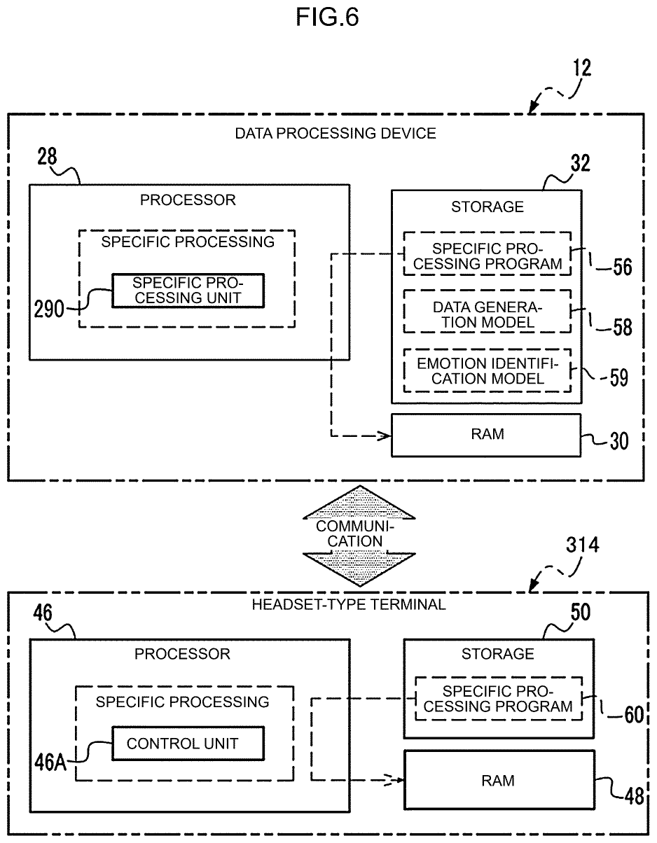

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described collection unit, classification unit, analysis unit, generation unit, and provision unit is implemented by at least one of, for example, a headset-type terminal 314 and a data processing apparatus 12. For example, the collection unit collects language data from a public database on the Internet via a communication I/F 44 of the headset-type terminal 314. The classification unit classifies the language data collected, for example, by a specific processing unit 290 of the data processing apparatus 12. The analysis unit analyzes the language data classified, for example, by the specific processing unit 290 of the data processing apparatus 12. The generation unit generates a new language based on information analyzed, for example, by the specific processing unit 290 of the data processing apparatus 12. The provision unit provides the new language generated, for example, by a control unit 46A of the headset-type terminal 314 to the user. The correspondence between each unit and the apparatus or control unit is not limited to the above examples and various modifications are possible.

### Fourth Embodiment

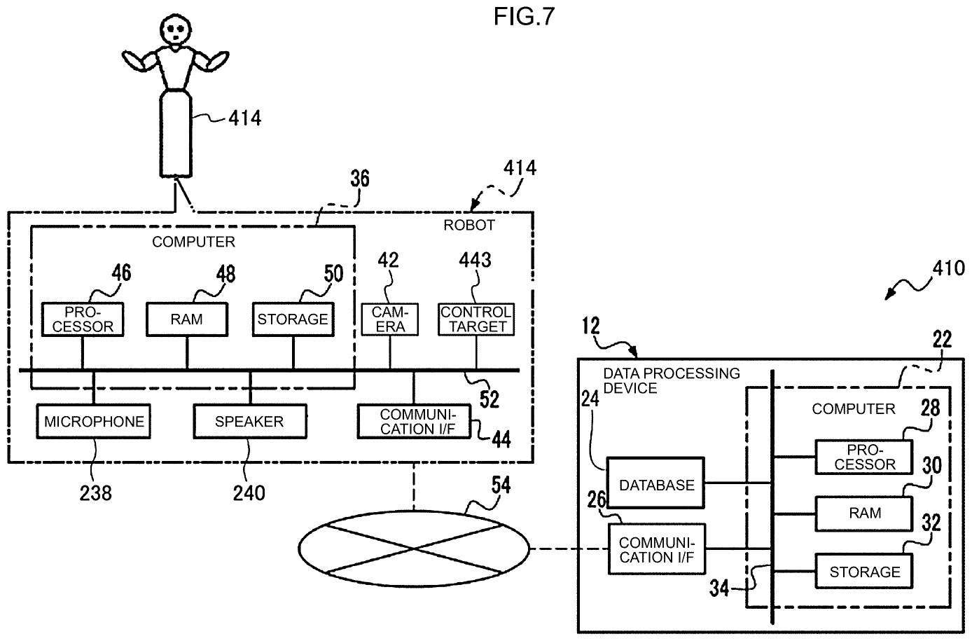

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

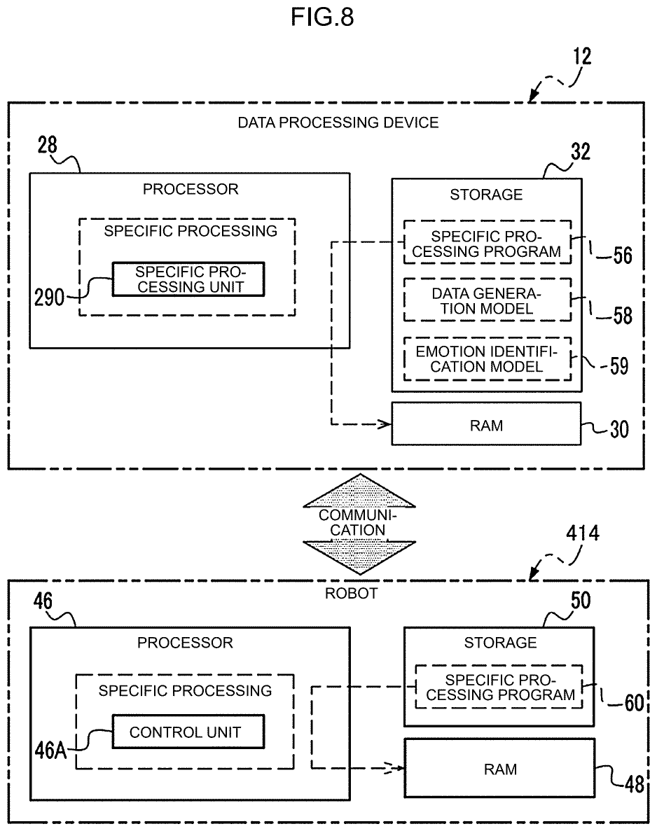

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described collection unit, classification unit, analysis unit, generation unit, and provision unit is implemented by at least one of, for example, a robot 414 and a data processing apparatus 12. For example, the collection unit collects language data from a public database on the Internet via a communication I/F 44 of the robot 414. The classification unit classifies the language data collected, for example, by a specific processing unit 290 of the data processing apparatus 12. The analysis unit analyzes the language data classified, for example, by the specific processing unit 290 of the data processing apparatus 12. The generation unit generates a new language based on information analyzed, for example, by the specific processing unit 290 of the data processing apparatus 12. The provision unit provides the new language generated, for example, by a control unit 46A of the robot 414 to the user. The correspondence between each unit and the apparatus or control unit is not limited to the above examples and various modifications are possible.

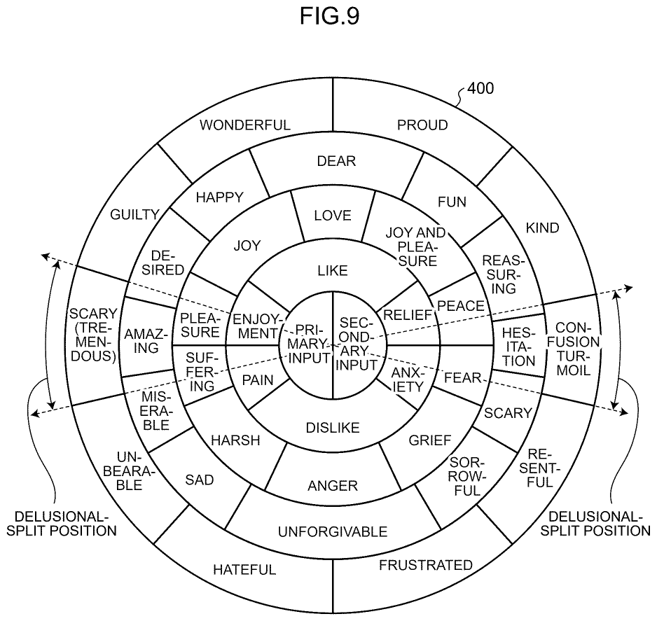

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related toemotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

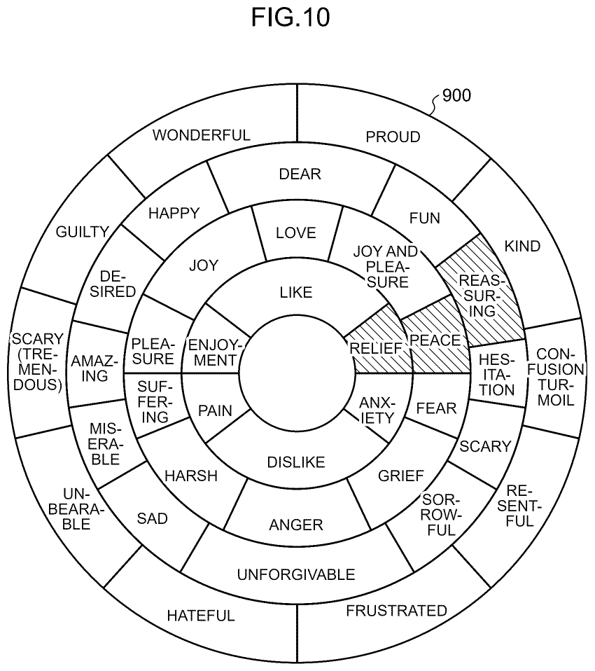

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a collection unit configured to collect languages of various countries and regions; a classification unit configured to classify the languages collected by the collection unit; an analysis unit configured to analyze the languages classified by the classification unit and analyze differences in meaning, nuance, and usage; a generation unit configured to generate languages based on information analyzed by the analysis unit; and a provision unit configured to provide the languages generated by the generation unit.
(Supplementary Note 2) The system according to Supplementary Note 1, wherein the collection unit is configured to estimate a user's emotion and adjust the timing of language collection based on the estimated emotion of the user.
(Supplementary Note 3) The system according to Supplementary Note 1, wherein the collection unit is configured to analyze the usage frequency of languages in various countries and regions and select a collection method.
(Supplementary Note 4) The system according to Supplementary Note 1, wherein the collection unit is configured to perform filtering based on the user's current field of interest or activity at the time of language collection.
(Supplementary Note 5) The system according to Supplementary Note 1, wherein the collection unit is configured to estimate a user's emotion and determine the priority of languages to be collected based on the estimated emotion of the user.
(Supplementary Note 6) The system according to Supplementary Note 1, wherein the collection unit is configured to preferentially collect highly relevant languages based on the user's geographic location information at the time of language collection.
(Supplementary Note 7) The system according to Supplementary Note 1, wherein the collection unit is configured to analyze the user's social media activity and collect related languages at the time of language collection.
(Supplementary Note 8) The system according to Supplementary Note 1, wherein the classification unit is configured to estimate a user's emotion and adjust the language classification criteria based on the estimated emotion of the user.
(Supplementary Note 9) The system according to Supplementary Note 1, wherein the classification unit is configured to refer to detailed data on culture and historical background during language classification to improve classification accuracy.
(Supplementary Note 10) The system according to Supplementary Note 1, wherein the classification unit is configured to classify languages based on usage scenes and context during language classification.
(Supplementary Note 11) The system according to Supplementary Note 1, wherein the classification unit is configured to estimate a user's emotion and adjust the display order of classification results based on the estimated emotion of the user.
(Supplementary Note 12) The system according to Supplementary Note 1, wherein the classification unit is configured to classify languages in consideration of geographic distribution during language classification.
(Supplementary Note 13) The system according to Supplementary Note 1, wherein the classification unit is configured to refer to related literature and materials during language classification to improve classification accuracy.
(Supplementary Note 14) The system according to Supplementary Note 1, wherein the analysis unit is configured to estimate a user's emotion and adjust the analysis method based on the estimated emotion of the user.
(Supplementary Note 15) The system according to Supplementary Note 1, wherein the analysis unit is configured to refer to past analysis data during language analysis to optimize the analysis algorithm.
(Supplementary Note 16) The system according to Supplementary Note 1, wherein the analysis unit is configured to analyze languages based on the purpose and usage of the language during language analysis.
(Supplementary Note 17) The system according to Supplementary Note 1, wherein the analysis unit is configured to estimate a user's emotion and adjust the display method of analysis results based on the estimated emotion of the user.
(Supplementary Note 18) The system according to Supplementary Note 1, wherein the analysis unit is configured to determine the priority of analysis based on the usage frequency and importance of the language during language analysis.
(Supplementary Note 19) The system according to Supplementary Note 1, wherein the analysis unit is configured to refer to other related data sources during language analysis to improve analysis accuracy.
(Supplementary Note 20) The system according to Supplementary Note 1, wherein the generation unit is configured to estimate a user's emotion and adjust the method of generating new languages based on the estimated emotion of the user.
(Supplementary Note 21) The system according to Supplementary Note 1, wherein the generation unit is configured to refer to past generation data during generation of new languages to optimize the generation algorithm.
(Supplementary Note 22) The system according to Supplementary Note 1, wherein the generation unit is configured to generate new languages based on usage scenes and context during generation.
(Supplementary Note 23) The system according to Supplementary Note 1, wherein the generation unit is configured to estimate a user's emotion and adjust the display method of generated languages based on the estimated emotion of the user.
(Supplementary Note 24) The system according to Supplementary Note 1, wherein the generation unit is configured to determine the priority of generation based on the usage frequency and importance of the language during generation of new languages.
(Supplementary Note 25) The system according to Supplementary Note 1, wherein the generation unit is configured to refer to other related data sources during generation of new languages to improve generation accuracy.
(Supplementary Note 26) The system according to Supplementary Note 1, wherein the provision unit is configured to estimate a user's emotion and adjust the method of providing new languages based on the estimated emotion of the user.
(Supplementary Note 27) The system according to Supplementary Note 1, wherein the provision unit is configured to refer to the user's past usage history during provision of new languages to select an optimal provision method.
(Supplementary Note 28) The system according to Supplementary Note 1, wherein the provision unit is configured to estimate a user's emotion and adjust the frequency of providing new languages based on the estimated emotion of the user.
(Supplementary Note 29) The system according to Supplementary Note 1, wherein the provision unit is configured to select an optimal provision method based on the user's device information during provision of new languages.

What is claimed is:

1. A system comprising:
circuitry configured to:
receive text data from a plurality of data sources, the text data associated with a plurality of geographic regions;
extract feature vectors from the received text data by applying a classification model;
generate a multidimensional tensor representing semantic differences across the plurality of geographic regions based on the extracted feature vectors;
generate output data by inputting the multidimensional tensor into a data generation model configured to perform neural network inference; and
transmit the output data to a client terminal via a packet-switched network.

2. The system according to claim 1, wherein the circuitry is further configured to estimate an emotion of a user based on sensor data received from the client terminal, and adjust a timing of receiving the text data based on the estimated emotion.

3. The system according to claim 1, wherein the circuitry is further configured to analyze a usage frequency of the text data across the plurality of geographic regions and select a collection method based on the analyzed usage frequency.

4. The system according to claim 1, wherein the circuitry is further configured to perform filtering of the text data based on a current field of interest of a user, the field of interest determined by analyzing at least one of browsing history, application usage history, or search queries received from the client terminal.

5. The system according to claim 1, wherein the circuitry is further configured to estimate an emotion of a user and determine a priority of the text data to be received based on the estimated emotion.

6. The system according to claim 1, wherein the circuitry is further configured to receive geographic location information from the client terminal and preferentially receive text data associated with a geographic region corresponding to the geographic location information.

7. The system according to claim 1, wherein the circuitry is further configured to analyze social media activity data associated with a user and receive text data related to languages used in the social media activity.

8. The system according to claim 1, wherein the classification model comprises a Transformer-based natural language understanding model configured to extract the feature vectors by performing tokenization and semantic structure analysis on the received text data.

9. The system according to claim 1, wherein the circuitry is further configured to classify the text data based on at least one of culture data, historical background data, or regional usage pattern data associated with the plurality of geographic regions.

10. The system according to claim 1, wherein the circuitry is further configured to classify the text data based on a usage scene and context associated with the text data, wherein the usage scene comprises at least one of business conversation, daily conversation, academic text, or social media post.

11. The system according to claim 1, wherein the circuitry is further configured to estimate an emotion of a user and adjust a display order of classification results based on the estimated emotion, such that when the estimated emotion indicates relaxation, detailed classification results are displayed, and when the estimated emotion indicates stress, simplified classification results are displayed.

12. The system according to claim 1, wherein generating the multidimensional tensor comprises analyzing differences in at least one of meaning, nuance, or usage of the text data across the plurality of geographic regions.

13. The system according to claim 1, wherein the circuitry is further configured to determine a priority of analysis based on a usage frequency and importance score associated with the text data.

14. The system according to claim 1, wherein the circuitry is further configured to retrieve reference data from an external data source comprising at least one of linguistic papers, dictionaries, or corpora, and incorporate the reference data into the neural network inference.

15. The system according to claim 1, wherein the circuitry is further configured to estimate an emotion of a user and adjust a format of the output data based on the estimated emotion, such that when the estimated emotion indicates relaxation, the output data is generated in a detailed format, and when the estimated emotion indicates stress, the output data is generated in a simplified format.

16. The system according to claim 1, wherein the data generation model comprises a recurrent neural network configured to perform time-series analysis on the multidimensional tensor.

17. The system according to claim 1, wherein the circuitry is further configured to retrieve a past usage history associated with a user from a database and select a provision method for the output data based on the past usage history.

18. A system comprising:
a communication interface configured to communicate with a client terminal via a packet-switched network;
a processor;
a random-access memory; and
a memory storing a classification model and a data generation model, the data generation model comprising a neural network, wherein the processor is configured to execute instructions stored in the memory to cause the system to:
receive, via the communication interface, text data from a plurality of data sources, the text data associated with a plurality of geographic regions and comprising at least one of language data, dialect data, or regional expression data;
extract feature vectors from the received text data by applying the classification model, the feature vectors comprising semantic features representing meaning, nuance, and usage characteristics;
generate a multidimensional tensor representing semantic differences across the plurality of geographic regions based on the extracted feature vectors by performing clustering analysis;
generate output data by inputting the multidimensional tensor into the data generation model to perform neural network inference, the output data comprising generated text that incorporates the semantic differences; and
transmit, via the communication interface, the output data to the client terminal.

19. The system according to claim 18, wherein the processor is further configured to estimate an emotion of a user based on at least one of facial image data, audio waveform data, or biometric sensor data received from the client terminal, and dynamically adjust at least one of a timing of receiving the text data, a priority of the text data, or a format of the output data based on the estimated emotion.

20. A method performed by circuitry of a system, the method comprising:
receiving text data from a plurality of data sources, the text data associated with a plurality of geographic regions;
extracting feature vectors from the received text data by applying a classification model;
generating a multidimensional tensor representing semantic differences across the plurality of geographic regions based on the extracted feature vectors;
generating output data by inputting the multidimensional tensor into a data generation model configured to perform neural network inference; and
transmitting the output data to a client terminal via a packet-switched network.
